(19) United States
(12) Patent Application Publication
(10) Pub. No.: US 2023/0024035 A1
(43) Pub. Date: Jan. 26, 2023

(54) ZERO-COPY SPARSE MATRIX FACTORIZATION SYNTHESIS FOR HETEROGENEOUS COMPUTE SYSTEMS

(71) Applicant: NEC Laboratories Europe GmbH, Heidelberg (DE)

(72) Inventors: Daniel Thuerck, Heidelberg (DE); Nicolas Weber, Heidelberg (DE)

(21) Appl. No.: 17/519,630

(22) Filed: Nov. 5, 2021

Related U.S. Application Data
(60) Provisional application No. 63/203,060, filed on Jul. 7, 2021.

(51) Int. Cl. G06F 17/16; G06F 17/12; G06N 7/00; G06F 9/30; G06F 15/80; G06F 12/02

(52) U.S. Cl. CPC G06F 17/16; G06F 17/12; G06N 7/005; G06F 9/30047; G06F 9/30101; G06F 15/8046; G06F 12/0246

(57) ABSTRACT

A system, method, and computer-readable medium for synthesizing zero-copy sparse matrix factorization operations in heterogeneous compute systems are provided. The system includes a host and an accelerator device. The host device is configured to divide an input matrix into a plurality of blocks which are transferred to a memory of the accelerator device. The host device is also configured to generate at least one index buffer that includes pointers to the block in the accelerator's memory, where each index buffer represents a frontal matrix associated with a matrix decomposition algorithm. The host processor is configured to receive one or more kernels configured to process the index buffer(s) on an accelerator device. The index buffers are processed by the accelerator device and the modified block data is written back to a memory of the host device to generate a factorized output matrix.

### CROSS-REFERENCE TO RELATED APPLICATION

Priority is claimed to U.S. Provisional Patent Application No. 63/203,060, filed on Jul. 7, 2021, the entire disclosure of which is hereby incorporated by reference herein.

### FIELD

The present invention relates to a method, system and computer-readable medium for zero-copy sparse matrix factorization synthesis for heterogeneous compute systems.

### BACKGROUND

Matrix factorization—e.g., the well-known Cholesky factorization of a symmetric positive definite matrix A into a product of lower-triangular matrices, expressed as:

A=LL^{T}

is a crucial computational kernel for applications in the computational sciences. Besides the classic usage for solving systems of linear equations, most algorithms for nonlinear optimization problems and nonlinear systems of equations rely on solving a series of nonlinear equations. Example applications for these type of computations include, but are not limited to:

Fluid dynamics simulations (e.g., weather predictions);

Finite element simulations (e.g., load simulations on airplanes);

Graph characterization through eigenvectors (e.g., PageRank algorithm);

Linear optimization (e.g., Interior Point method, Simplex method); and

(Non-) linear integer optimization (e.g., logistics planning and fleet optimization).

With problem sizes increasing far beyond the memory capabilities of current systems, researchers and practitioners are commonly employing sparse data, i.e., matrices that do not explicitly store numerical zeros.

This seemingly trivial change leads to a series of challenges when computing with sparse data. Compared to dense data, random access into a sparse matrix (or tensor) requires multiple indirections and possibly symbolic operations. This affects the system's performance in a negative way due to, e.g., losing cache efficiency. Furthermore, changing the structure of sparse data frequently requires re-creating its indexing structure, leading to higher memory demands and compute times.

In the case of sparse matrix factorization these issues work together, leading to a slowdown of factor 100× (and more) if implemented naively. First, the structure of L changes during the computation, leading to frequent symbolic computations. Second, the lack of contiguous storage for rows/columns of the matrix severely degrade the efficiency of the numerical operations. Hence, in the last three decades, the so-called “multifrontal” (or, more generally, “supernodal”) method for sparse matrix factorization has become the de-facto standard.

FIG. 1 illustrates a principle of a multifrontal method for sparse factorization, in accordance with the prior art. As depicted in FIG. 1, the conventional multifrontal method first identifies the order of rows and columns being modified and stores this in the “elimination tree”. Subsequent rows/columns (“nodes”) in this tree with a similar nonzero structure of their respective rows/columns are amalgamated into “frontal” matrices. Within these dense “frontal” matrices, linear algebra operations are executed in highly efficient, vendor provided BLAS (basic linear algebra subprograms) kernels. In order to arrive at peak performance, these BLAS kernels often use caching effects through cache-friendly tiling and special hardware features such as SIMD- or vector processors. BLAS-kernels themselves are highly specialized pieces of code and often are hand-optimized to reach 95% and beyond of the processor's peak performance.

At the same time, the landscape of computer architecture is changing dramatically. Today's systems are dominated by heterogeneous setups where a CPU (“host”) is combined with one or multiple types of compute accelerators (“device”). These accelerators could be, e.g., GPUs (graphics processing units), TPUs (tensor processing units), systolic arrays, programmable FPGAs, or vector cards. In general, accelerators offer a higher compute throughput than CPUs but are somewhat restricted in their programmability and need a “host” system for feeding it data and jobs.

For many types of such compute accelerators, their vendors supply a library of popular BLAS kernels. Through the multifrontal method, these accelerators are leveraged in a straightforward way. Instead of executing using a BLAS kernel on the CPU, a frontal matrix is copied onto an accelerator device and processed on the accelerator device. Upon completion of the processing, the frontal matrix is transferred back and either scattered into the original matrix or kept on a stack. Because scatter/gather types of memory access are inefficient on accelerators, these are limited to the CPU (“host”), in this example.

### SUMMARY

Embodiments of the present disclosure provide systems and a method for synthesizing zero-copy sparse matrix factorization operations. The method includes dividing, by a host device, an input matrix into a plurality of blocks stored in a memory. The input matrix comprises a sparse matrix including zero values and non-zero scalar values and each block in the plurality of blocks represents a portion of the sparse matrix that includes at least one non-zero scalar value. The method further includes generating at least one index buffer that includes pointers to the blocks in the memory, creating one or more kernels configured to process the at least one buffer on an accelerator device, transmitting the at least one buffer to the accelerator device, modifying data on the accelerator device responsive to executing the one or more kernels for the one or more buffers, and generating a factorized output matrix based on the block data. Each index buffer corresponds to a frontal matrix associated with a matrix decomposition algorithm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a principle of a multifrontal method for sparse factorization, in accordance with the prior art.

FIG. 2 illustrates an input matrix that is subdivided into blocks and applying the multifrontal method to these blocks, in accordance with an embodiment.

FIG. 3 illustrates an aspect of BLAS kernels, where operations are ideally ordered in a way that respects the processor's cache hierarchy, in accordance with an embodiment.

FIG. 4. illustrates the principle of operation of BLAS-like kernels that consume an index buffer as input, in accordance with an embodiment.

FIG. 5 illustrates python source code for the Cholesky factorization of an n×n matrix A, in accordance with an embodiment.

FIG. 6 relates to a multifrontal method using an accelerator device, in accordance with the prior art.

FIG. 7 relates to a multifrontal method that uses BLAS-like (“iBLAS”) operations that load blocks of the matrix into scratchpad memory on an as-needed basis, in accordance with an embodiment.

FIG. 8 illustrates a fragment out of a computational graph the code of FIG. 5 is instantiated for a 4×4 matrix stored in 2×2-sizes blocks, in accordance with an embodiment.

FIG. 9 illustrates a possible order of operations that is gained through a steered topological sort of the DAG in FIG. 8, in accordance with an embodiment.

FIG. 10 illustrates a compilation process and the partitioning of the code of FIG. 5 into subkernels, in accordance with an embodiment.

FIG. 11A illustrates a flowchart of a method for synthesizing zero-copy sparse matrix factorization operations, in accordance with an embodiment.

FIG. 11B illustrates a flowchart of a method for creating an indexed basic linear algebra subprogram (iBLAS) kernel, in accordance with an embodiment.

FIG. 12 illustrates a flowchart of a method for processing an index buffer by an iBLAS, in accordance with an embodiment.

FIG. 13A illustrates an accelerator device, in accordance with an embodiment.

FIG. 13B illustrates an accelerator device, in accordance with another embodiment.

FIG. 14 illustrates a system for synthesizing zero-copy sparse matrix factorization, in accordance with an embodiment

FIG. 15 illustrates the theoretical PIRCH architecture, in accordance with an embodiment.

FIG. 16 illustrates the mapping of an OpenCL program fragment to PIRCH registers, in accordance with an embodiment.

FIG. 17 shows an example intermediate representation (IR) for a fragment of kernel code, in accordance with an embodiment.

FIG. 18 illustrates a subset of grammar of OpenCL C used by the borG compiler frontend, in accordance with an embodiment.

FIG. 19 is a schematic illustration of the borG compiler, in accordance with an embodiment.

FIG. 20 is an example of a code transformations performed by the borG frontend, in accordance with an embodiment.

FIG. 21 is an example of a code for a static pivoting LDU-kernel implementation for borG, in accordance with an embodiment.

FIG. 22 illustrates a normal store/gather operation as well as cross-lane shuffle/reorder operations for SIMD architectures, in accordance with an embodiment.

FIG. 23 illustrates chunking of an InfReg to native SIMD vector width, in accordance with an embodiment.

### DETAILED DESCRIPTION

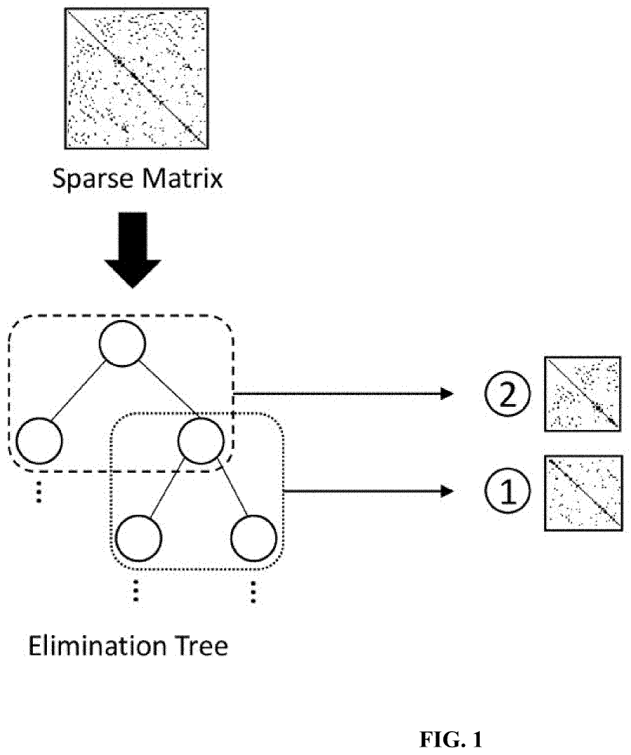

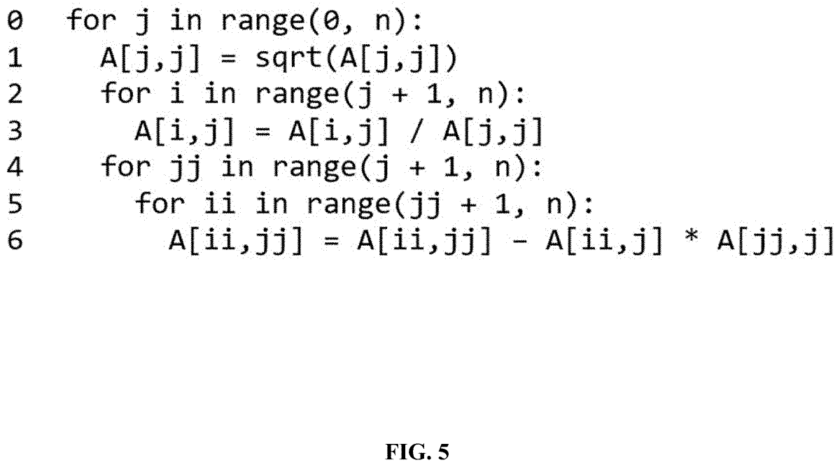

Those of skill in the art may recognize that the conventional multifrontal method has several downsides. The first example of a downside includes the introduction of multiple transfer latencies related to transferring multiple frontal matrices to the host device. Consider a sequence diagram of a multifrontal method using an accelerator (e.g., device), such as the accelerator shown in FIG. 5, with reference to the frontal matrices shown in FIG. 1. Each frontal matrix is individually copied and processed on the device. Depending on the capabilities of the device, multiple independent frontal matrices can be transferred and processed individually. However, as shown in the example of FIG. 5 with matrices (1) and (2), in the case where there are data dependencies, the necessary transfers back to the host and matrix assembly therein may incur multiple transfer latencies. In effect the benefit of using the higher computational power of an accelerator may be reduced due to these latencies.

A second example of a downside includes restrictions based on the provided libraries for the accelerator. For example, only specific types of computations (e.g., matrix factorization types) may be supported by a particular accelerator, for which the accelerator's vendor may supply the matching BLAS kernels. If the supplied BLAS kernels are not suitable for a particular application, then custom-built kernels may be needed. However, custom-built kernels, especially when designed to support multiple accelerator architectures, may have difficulty reaching peak performance levels. Embodiment of the present disclosure, however, address these and other limitations of current multifrontal methods.

Embodiments of the present disclosure provide a portable system and method to synthesize buffer-less (“zero-copy”) BLAS-like computational kernels for various kinds of compute accelerator architectures featuring large register capacities. The resulting programs seemingly apply linear algebra operations to dense tensors by transparently mapping accesses to individual elements therein to the register cache. The latter are filled through customized loading and storing routines for contiguous sub-tensors.

In effect, methods according to the present disclosure permit the implementation of a system that performs operations on sparse tensors efficiently by storing all matrix data in a blocked, heterogeneous format in the accelerator's device memory thus removing latencies through host/device transfers.

Embodiments of the present disclosure provide an adaptive format for block sparse matrices where each block i can be stored in a user-defined format tᵢ and converted from/to a dense tile by the means of custom storing and loading operations (Sᵢ, Lᵢ).

In an embodiment of the present disclosure, a method is provided for creating BLAS-like kernels for heterogeneous hardware. The method includes:
a) creating a static instruction-DAG out of a high-level description of the task and annotating its nodes with regard to the block inside an index buffer they depend on;
b) traversing the DAG in a manner that minimizes the number of block-store and -load operations; and
c) inserting these operations where necessary to issue a kernel that processes dense matrices that are represented through index buffers pointing to blocks of various formats.

An embodiment of the present disclosure provides a process for partitioning the operations scheduled into “subkernels”, where all instructions in one partition only modify one block each. These subkernels can then, as an alternative to a default multifrontal approach of asynchronously processing multiple branches of the elimination tree, be scheduled as a series of batched operations.

An embodiment of the present invention may be executed in at least one system or accelerator with a high register capacity. Here, the system may define n×n block formats t₁, t₂, . . . and load/store procedures (L₁, S₁), (L₂, S₂), . . . as required. The system may create kernels for processing N×N matrices for multiple N consuming nb×nb index buffers of pointers to blocks in device memory by reordering their instructions w.r.t to minimizing the use of the provided load/store instructions. The system may implement a frontend, executing the steps of a “zero-copy” factorization on the “host” side. The frontend then calls either the kernels or subkernels (for batched mode) created in the previous steps, as necessary.

Embodiments of the present disclosure include a method for an efficient sparse matrix factorization using synthesized, zero-copy BLAS (referred to herein as indexed BLAS or “iBLAS”) operations, which minimizes the latencies caused by transfers between a host and an accelerator device.

In accordance with one aspect of the present disclosure, a method for synthesizing zero-copy sparse matrix factorization operations is provided. The method includes the steps of: dividing, by a host device, an input matrix into a plurality of blocks stored in a memory, generating at least one buffer that includes pointers to the blocks in the memory, creating one or more kernels configured to process the at least one buffer on an accelerator device, transmitting the at least one buffer to the accelerator device, receiving block data generated by the accelerator device responsive to executing the one or more kernels for the one or more buffers, and generating a factorized output matrix based on the block data. The input matrix comprises a sparse matrix including zero values and non-zero scalar values and each block in the plurality of blocks represents a portion of the sparse matrix that includes at least one non-zero scalar value. Each buffer represents a frontal matrix associated with a matrix decomposition algorithm.

In accordance with one embodiment of the first aspect, the dividing the input matrix into the plurality of blocks comprises processing the input matrix via at least one permutation operation such that a number of blocks containing non-zero scalar values is minimized.

In accordance with one embodiment of the first aspect, the plurality of blocks comprise a first block associated with a first format and a second block associated with a second format that is different than the first format.

In accordance with one embodiment of the first aspect, the first format corresponds to a first load procedure that loads a non-zero scalar value in the first block from the memory to a register cache of the accelerator device in accordance with a first precision and/or a first store procedure that stores the non-zero scalar value for the first block in the register cache to the memory in accordance with the first precision. The second format corresponds to a second load procedure that loads a non-zero scalar value in the second block from the memory to the register cache of the accelerator device in accordance with a second precision and/or a second store procedure that stores the non-zero scalar value for the second block in the register cache to the memory in accordance with the second precision.

In accordance with one embodiment of the first aspect, creating the one or more kernels comprises compiling code in an intermediate representation to generate the one or more kernels for the accelerator device.

In accordance with one embodiment of the first aspect, the code comprises indexed basic linear algebra subprogram (iBLAS) kernels in a low level virtual machine intermediate representation (LLVM-IR).

In accordance with one embodiment of the first aspect, the method further includes the steps of: processing source code to collect scalar accesses to elements within the input matrix resulting from execution of instructions in the source code, inserting the instructions into a directed acyclic graph (DAG) in accordance with data dependencies corresponding to the scalar accesses to the elements, associating each instruction in the DAG with a marker that identifies the block corresponding to the instruction, traversing the DAG to create a sequence of instructions minimizing a number of load and/or store operations, mapping the instructions to a register cache, and compiling a modified source code in an intermediate representation based on the mapping, wherein the modified source code includes load and/or store operations that reference the buffers.

In accordance with one embodiment of the first aspect, the register cache comprises a collective register cache (CoRe) model that defines a plurality of infinite registers. Multiple variables with non-intersecting liveness ranges and compatible type can be mapped to a single infinite register, and different variables that interact are mapped to a particular lane of different infinite registers.

In accordance with one embodiment of the first aspect, the accelerator device comprises at least one of a graphics processing unit (GPU), a tensor processing unit (TPU), a systolic array, a field programmable gate array (FPGA), or a vector processor.

In accordance with a second aspect of the present disclosure, a system is provided that includes a memory storing an input matrix and a processor coupled to the memory. The processor is configured to: divide the input matrix into a plurality of blocks stored in the memory, generate at least one buffer that includes pointers to the blocks in the memory, create one or more kernels configured to process the at least one buffer on an accelerator device, transmit the at least one buffer to the accelerator device, receive block data generated by the accelerator device responsive to executing the one or more kernels for the one or more buffers, and generate a factorized output matrix based on the block data. The input matrix comprises a sparse matrix including zero values and non-zero scalar values, and each block in the plurality of blocks represents a portion of the sparse matrix that includes at least one non-zero scalar value. Each buffer represents a frontal matrix associated with a matrix decomposition algorithm.

In accordance with one embodiment of the second aspect, the plurality of blocks comprise a first block associated with a first format and a second block associated with a second format that is different than the first format.

In accordance with one embodiment of the second aspect, the processor is further configured to: process source code to collect scalar accesses to elements within the input matrix resulting from execution of instructions in the source code, insert the instructions into a directed acyclic graph (DAG) in accordance with data dependencies corresponding to the scalar accesses to the elements, associate each instruction in the DAG with a marker that identifies the block corresponding to the instruction, traverse the DAG to create a sequence of instructions minimizing a number of load and/or store operations, map the instructions to a register cache, and compile a modified source code in an intermediate representation based on the mapping. The modified source code includes load and/or store operations that reference the buffers.

In accordance with one embodiment of the second aspect, the register cache comprises a collective register cache (CoRe) model that defines a plurality of infinite registers. Multiple variables with non-intersecting liveness ranges and compatible type can be mapped to a single infinite register, and different variables that interact are mapped to a particular lane of different infinite registers.

In accordance with one embodiment of the second aspect, the processor comprises a central processing unit (CPU) and the accelerator device comprises a graphics processing unit (GPU).

In accordance with a third aspect of the present disclosure, a non-transitory computer readable storage media is provided that stores instructions that, responsive to execution on a host computer, cause the host computer to perform operations in accordance with the method of the first aspect.

In the following, the discussion is focused on matrices, although the same holds true for tensors of all dimensionalities. As such, a person of ordinary skill in the art would understand that embodiments of the present disclosure are not so limited.

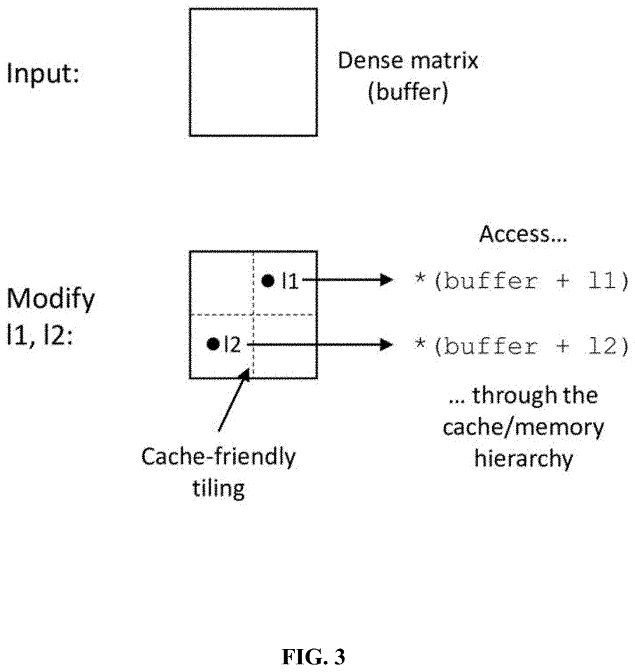

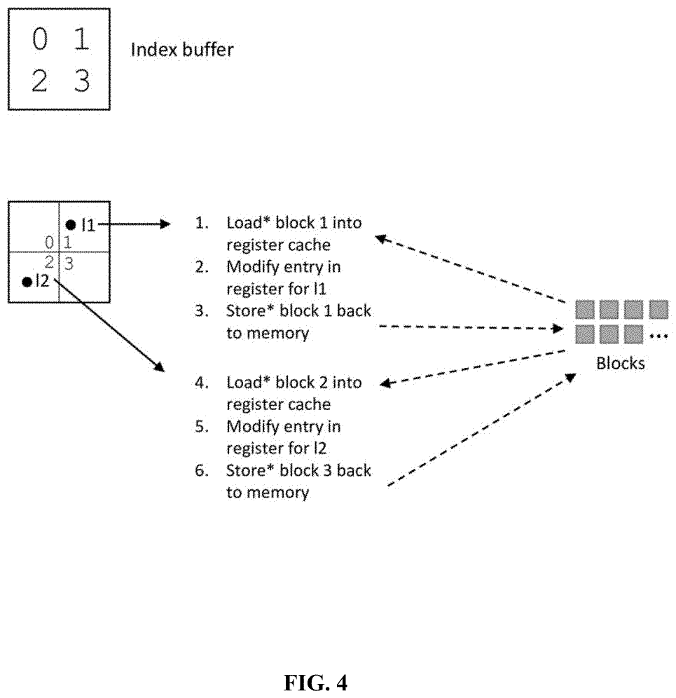

Conventional BLAS kernels, such as that shown in FIG. 3, operate on a contiguous chunk of memory passed as a buffer. This buffer contains the matrix either in row-major or column-major fashion with possible empty alignment space. Inside the conventional BLAS kernels, the matrix may be further decomposed into tiles to fit the systems' cache design better. Conventional BLAS kernels can directly access any location within the buffer through a simple offset; vendors often optimize the order of the operations in order to leverage cache effects and SIMD/vector units. On accelerators such as GPUs, the full memory hierarchy including shared memory is used to buffer parts of the matrix. However, a common trait in all these implementations is that the matrix data is located in memory in plaintext. Hence, when used as part of a sparse multifrontal algorithm, data needs to be temporarily held in multiple buffers. Thus, data dependencies between buffers lead to the latencies caused by host/device transfers, as illustrated in FIG. 4.

These data dependencies are rooted in the dynamic creation of buffers (i.e., “frontal matrices”) for subsequent amalgamated notes within the elimination tree in the multifrontal method. When cache-friendly BLAS kernels are used, these dynamically allocated buffers are further split into tiles.

According to an aspect of the present disclosure, the conventional multifrontal process is turned upside-down. Instead of allocating dense buffers, gathering elements from the sparse matrix to populate the buffer, only to tile the resulting buffer, an alternative approach may be used. First, the tiles may be directly created within the sparse matrix, and then virtual buffers are assembled on top of these tiles. Contrary to the conventional multifrontal method, these tiles are created once, at the start of the factorization (hence, they are static).

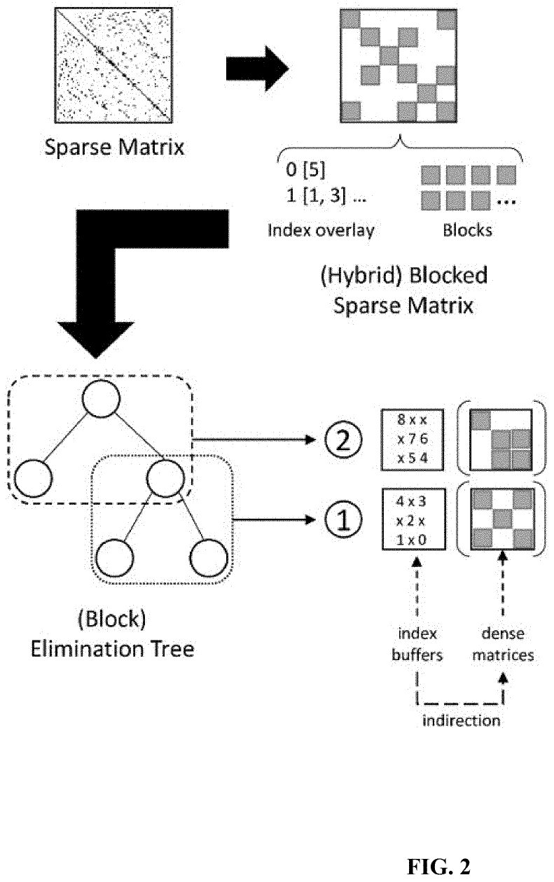

The resulting process is illustrated in FIG. 2. First, the matrix is preprocessed by permuting its rows and columns in a way that puts nonzero entries spatially closer together, creating small regions that are close to dense. This can be achieved through a graph partitioning tool such as METIS. Next, the sparse matrix is overlayed with a regular grid with cell size n>0, where n is a tunable parameter for the problem at hand.

Each grid cell that contains at least one nonzero entry subsequently creates one dense tile in a new, block-sparse matrix. The dense tiles are shown as shaded in FIG. 2. The resulting blocks are then organized through index overlays, i.e., compressed data structures such as CSR or CSC (compressed sparse row/column) formats where, instead of numerical values, pointers to the dense tile are stored.

As today's high performance computing (HPC) systems process larger and larger problems, it is often beneficial to adapt data structures utilized by algorithms to the problem at hand in order to leverage the data's properties for memory savings or performance increases. One aspect of the present disclosure is the flexibility to employ various adaptive storage formats for these tiles without additional work on the user's side.

After the preprocessing process above, the sparse matrix is represented by a (set of) index overlay(s) and the tiles in the form of n×n-sized, dense buffers. At this point, the user can specify a set of formats t₁, t₂, . . . and load/store procedures (L₁, S₁), (L₂, S₂), . . . and associate each tile with one of the formats. Examples of such formats and their applications are discussed below. Before starting the actual factorization, all tiles are converted into the associated format and stored as binary buffers that can be converted to and from dense numerical buffers by the means of the associated load/store operations. In the remainder of this document, we call these formatted tiles “blocks”.

When factorizing such a block matrix, the method then proceeds as in the conventional multifrontal method, by traversing the (amalgamated) elimination tree. In the case of scalar matrices, the elimination tree is generated through a symbolic analysis that discovers data dependencies between matrix rows and columns induced by their nonzero entries. In a second step, contiguous parts of this tree, i.e., sets of rows and columns, are grouped into single amalgamated nodes. These nodes correspond to small matrices, the so-called frontal matrices that are explicitly generated by copying data. For block matrices, the nodes in the elimination tree already correspond to block rows and columns. Instead of creating explicit buffers, frontal matrices are represented by small index buffers, i.e., small matrices of pointers to the actual blocks in memory containing these block rows/columns. An m×m index buffer thus describes an (m×n)×(m×n) frontal matrix (see, e.g., FIG. 2).

As embodiments forego the use of explicit buffers to assemble frontal matrices, embodiments also forego the opportunity to use vendors' provided, highly-tuned BLAS kernels. Instead, embodiments use a custom compilation process to create BLAS-like kernels that are equivalent to BLAS kernels, but use the index buffers as a second layer of indirection. For example, the compilation process for a frontal matrix size may be described as: N×N=(n×nb)×(n×nb), where nb>0, and the corresponding index buffer size n×n. As stated before, each type of block t, there is a tuple (Lₜ, Sₜ) of custom load and store functions that load blocks (store blocks) of type t into a (from a) set of hardware registers.

The principal idea how these kernels operate is sketched in FIG. 4. Whenever an entry within the N×N matrix needs to be accessed, embodiments first load the corresponding block (of type t) via Lₜ into a set of hardware registers on the accelerator(s) (in the following, we refer to this set of registers as “register cache”). Within the register cache, scalar accesses, much like regular kernels, are possible. When the register cache needs to be freed, embodiments use Sₜ to store the block back to memory. Overall, the procedure allows working on dense matrices whose parts are scattered over the device memory without the requirement of allocating an extra buffer.

Instead, the procedure only receives a small index buffer containing raw pointers to the individual blocks. As shown in “Flynn's reconciliation: Automating the register cache idiom for cross-accelerator programming”, D. Thuerck et al, ACM TACO 2021 (the entire contents of which is hereby incorporated by reference herein), for large enough n, within a single n×n block, synthesized register cache implementations can rival hand-tuned, dedicated implementations of linear algebra kernels.

Embodiments of the present disclosure employ this knowledge and extend it to larger matrix sizes N>n through an automated process that is described herein.

It may be assumed that a piece of source code is given in an appropriate programming language that describes a series of static, runtime-value independent, instructions modifying a N×N matrix, see, e.g., Listing 1 (FIG. 5) in Python. Furthermore, the compiler is told how many slots the program has to hold blocks in the register. A compiler may then proceed as follows.

The compiler statically executes the code to collect all scalar accesses to elements within the input matrix. The instructions are inserted into a directed acyclic graph (DAG) according to data dependencies of the instructions. In other words, the compiler builds a DAG based on the static execution of the code according to the data dependencies based on the accesses of the elements in the input matrix. Each instruction in the DAG is associated with a marker, which describes the nb×nb block of the matrix that the instruction belongs to (i.e., is associated with).

The compiler traverses the DAG to in order to create a sequence of instructions that minimizes the number of color changes of the markers, corresponding to a steered topological sort. A color change may refer to an instruction, in a sequence of instructions, that operates on a different block than the previous instruction(s). The compiler is configured to insert corresponding load and/or store instructions in the sequence of instructions for the kernel before and after each color change of a marker. For examples, a load instruction to load the block to be operated on by the next instruction is inserted before the color change of the marker. The load instruction corresponds to the block associated with the marker after the color change. A store instruction to store block data in the register cache modified by one or more previous instructions to the memory can be inserted after the color change of the marker. The store instruction corresponds to a block associated with the marker prior to the color change. The load and/or store instructions may be selected in accordance with a type of the blocks corresponding to the instruction.

All of the instructions, except for the inserted load and/or store instructions, may be mapped to the register cache of the accelerator device. The compiler may be configured to assign data to the registers in the cache in a manner that is consistent with the available number of registers and data dependencies of the instructions.

In some embodiments, the resulting code in the sequence of instructions, including the inserted load and/or store instructions, can be created in an intermediate representation such as LLVM-IR, which is a single static assignment (SSA)-based low level representation, and subsequently compiled by a source-to-source compiler that maps a code that is architecture agnostic to a target architecture for the accelerator device, such as an Advanced Vector eXtensions (AVX) architecture, a single instruction, multiple thread (SIMT) architecture, or a single instruction, multiple data (SIMD) architecture.

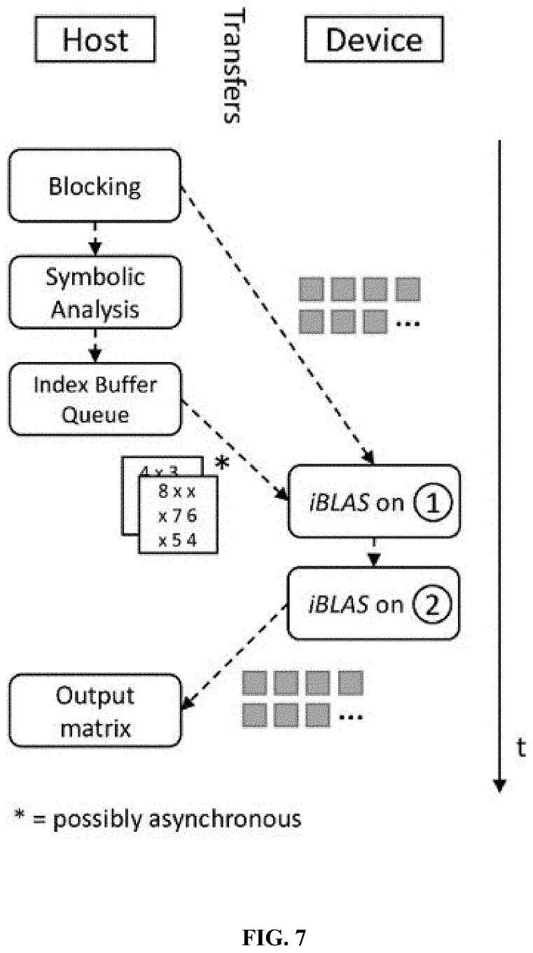

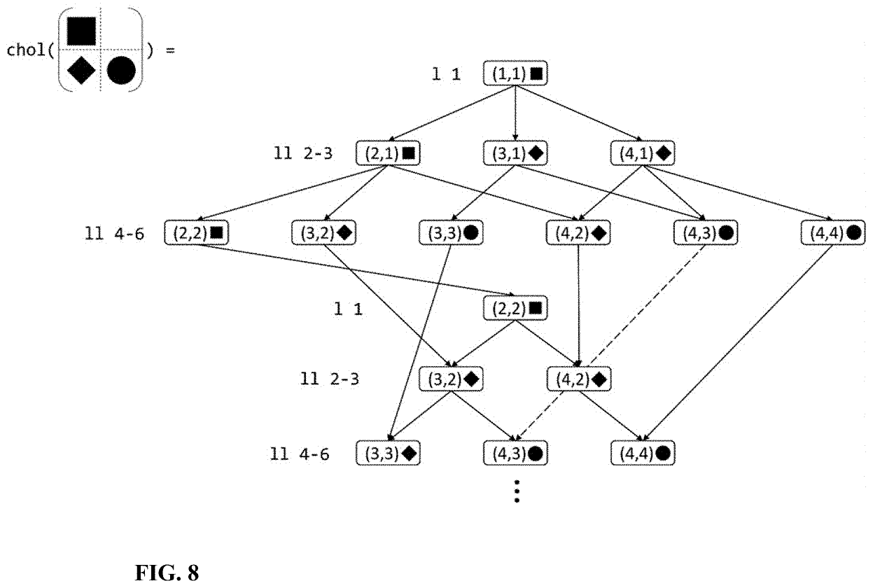

This process is illustrated in FIGS. 7, 8 and Listing 1. The Python code for a Cholesky factorization FIG. 1 is unrolled for a 4×4 matrix A that is split into 2×2 blocks and structured as a data dependency DAG. Each row in the graph's depiction corresponds to one or more lines of source code in Listing 1 (FIG. 5). Arrows depict data dependencies and induce an ordering of operations.

In order to synthesize a kernel factorizing A, a steered topological sort, as set forth above, is then performed on the DAG by traversing it. During the traversal, embodiments strive to minimize the change in the markers as this leads to less block-store and -load operations. One possible result of this traversal is depicted in FIG. 8 which also lists which blocks are loaded and stored. Compared to the natural (level-wise) order, two loading- and storing-operations are saved.

As a result, an executable code function is obtained that computes a BLAS-like function working on a “virtual” N×N matrix by mapping all scalar accesses to blocks of various data formats, loading/storing them when appropriate. Later, in the application, users only pass a nb×nb matrix filled with indices or pointers to blocks in device memory.

The method can be extended to N×N×N₁×N₂× . . . tensors through appropriate parameters n₁, n₂, . . . , nb₁, nb₂, . . . and following the steps above.

The compilation process offers another advantage: As depicted in FIG. 8, the process can group subsequent operations into “subkernels”, with the restriction that each subkernel may only write to one block. Thereby, the factorization of a frontal matrix is equivalent to a series of such sub-kernels, each modifying one block of the frontal matrix.

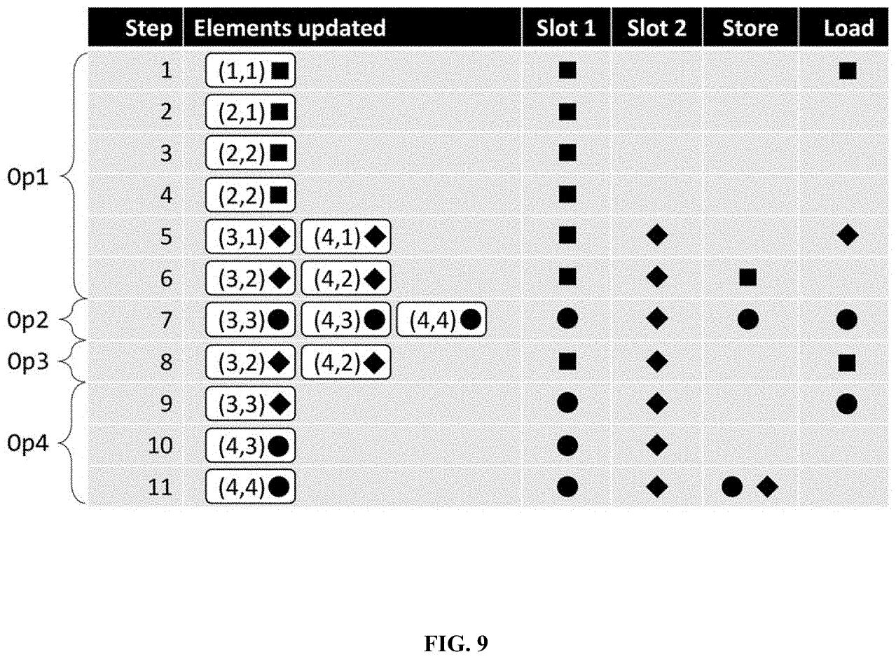

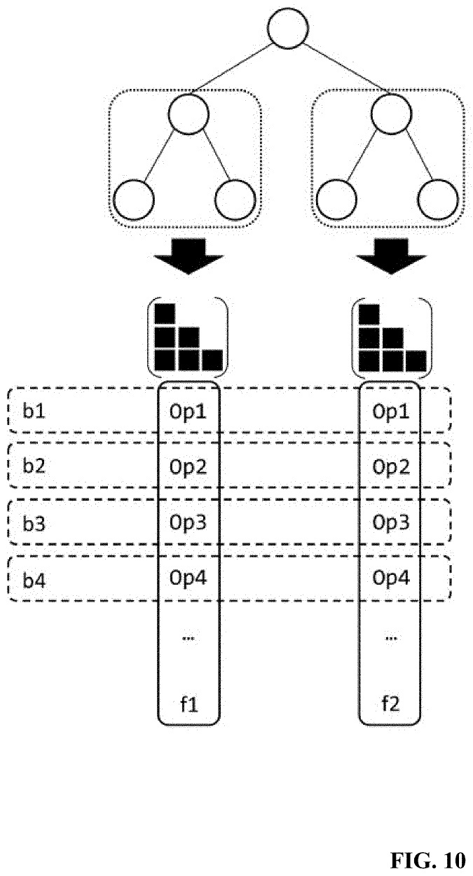

Following the schematic laid out in FIG. 10, two modes of execution are available. First, when following the default multifrontal pattern, frontal matrices may be factored using iBLAS kernels, with nonintersecting nodes being processed in parallel (FIG. 10, f1 and f2). Second, we can schedule the same subkernels (e.g., Op1, Op2, . . . , from FIG. 9) across branches of the elimination tree in the form of batches where the same operation is executed on a large set of blocks. This mode suits pipelined systems such as FPGAs.

### Exemplary Embodiments

### Accelerator-Friendly Sparse Matrix Factorization

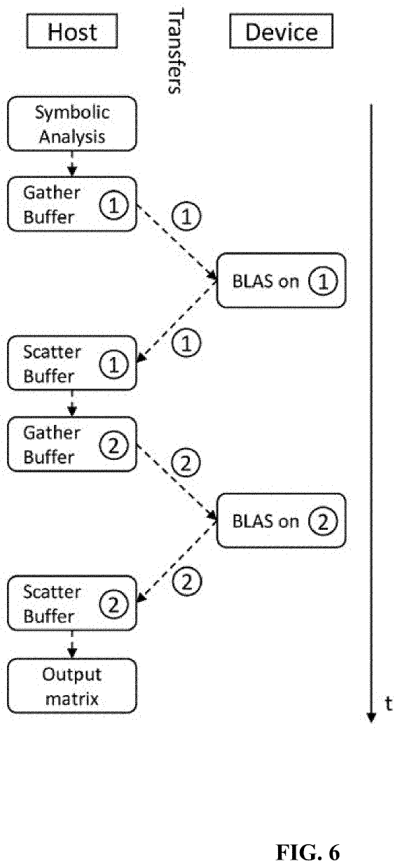

An exemplary embodiment of the above-described method is a “zero-copy” sparse matrix factorization, as depicted in FIG. 7. Other than the conventional multifrontal method depicted in FIG. 6, such a sparse matrix factorization could proceed as follows.

An input matrix, which is a sparse matrix with zero and non-zero scalar values, is processed in such a way (e.g., via permutation operations) that dividing the input matrix into a plurality of blocks minimizes the number of blocks that contain non-zero scalar values. An index overlay is created on the host device that organizes the input matrix using a compressed data structure of pointers to the blocks in the memory. Each block can have a different format, such that the input matrix is stored in the memory in a hybrid matrix storage format.

A symbolic analysis can be performed on the block-elimination tree and one or more index buffers with pointers to the blocks are created that represent all frontal matrices that need to be decomposed. The index buffers are then uploaded to the accelerator device in an order that does not cause write hazards. A sequence of computations is then performed on the index buffers using iBLAS kernels compiled for the accelerator device. It will be appreciated that the iBLAS kernels can include load instructions that cause block data for one or more blocks of the input matrix to be loaded into a local memory (e.g., a register cache) of the accelerator device. Thus, the block data stored in a memory of the host device is loaded into the memory of the accelerator device in potentially varying formats associated with each block.

After the computations are complete, and the one or more index buffers have been processed, the block data modified by the accelerator device can be transferred back to the memory of the host device, and the host device can generate and output the factorized scalar matrix.

In this factorization method, there are no delays due to data transfers caused by data dependencies between host and device memory. Furthermore, the processing of different index buffers may be interleaved for additional speedups if the accelerator device offers that feature.

As a possible extension, the blocks formats can be chosen in such way that the matrix has various degrees of accuracy or compression over different blocks, thus effectively generating code for approximate computing.

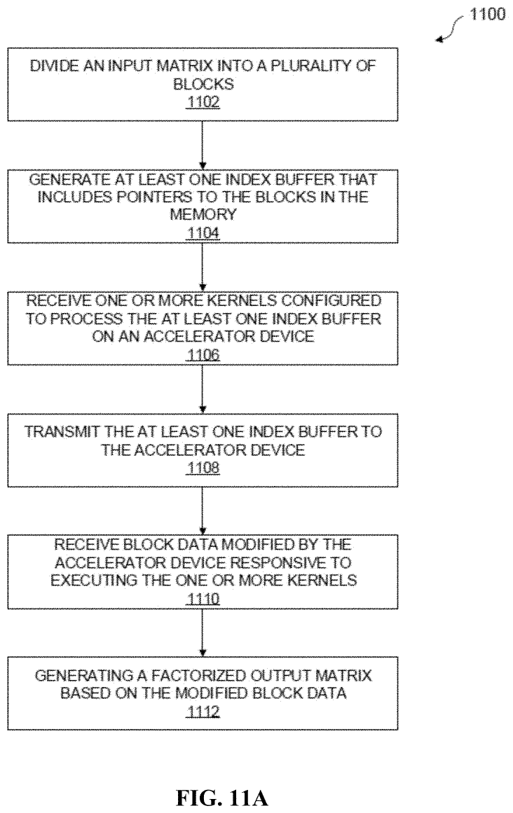

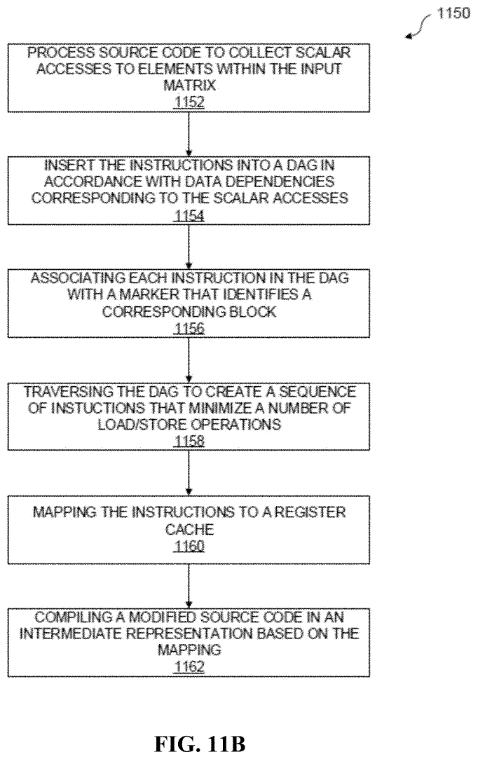

FIG. 11A illustrates a flowchart of a method 1100 for synthesizing zero-copy sparse matrix factorization operations, in accordance with an embodiment. The method 1100 may be performed by a host device.

At 1102, an input matrix is divided into a plurality of n×n blocks. In an embodiment, the input matrix is pre-processed via one or more permutation operations that, when the input matrix is divided into the plurality of n×n blocks, minimizes the number of blocks that include at least one non-zero scalar value. The data for the plurality of blocks may be stored in a memory associated with the accelerator device.

At 1104, at least one index buffer is generated that includes pointers to the blocks in the memory. Each index buffer represents a frontal matrix associated with the input matrix. In an embodiment, an elimination tree is traversed in order to generate the at least one index buffer.

At 1106, one or more kernels are received, where each kernel is configured to process at least one index buffer by an accelerator device. In an embodiment, the kernels are iBLAS kernels that are compiled for a target architecture from an LLVM intermediate representation (LLVM-IR).

At 1108, the at least one index buffer and the plurality of blocks are transmitted to the accelerator device. In an embodiment, the index buffers can be transferred in a manner that does not cause write hazards. The plurality of blocks may be copied from a memory of the host device to a memory associated with the accelerator device. The accelerator device processes the index buffers using the one or more iBLAS kernels, loading and storing the block data for individual blocks from the memory into a register cache on the accelerator device as needed using the pointers included in the index buffers. It will be appreciated that the iBLAS kernels are optimized to use load and store operations in a manner that minimizes latencies in the data transfer from the host to the accelerator device.

At 1110, block data modified by the accelerator device is received in a memory of the host device. In an embodiment, the modified block data is stored back to a memory associated with the host device based on store operations included in the iBLAS kernels that cause block data in the register cache of the accelerator device to be written out to the memory associated with the accelerator device, which can then be copied into the memory of the host device. In some embodiments, the host device and the accelerator device can use a shared memory. Typically, the block data is not written out to the memory of the host device after the completion of the processing of an index buffer, but is written out block by block as each block is processed, based on the store operations included in the iBLAS kernel.

At 1112, a factorized output matrix is generated by the host device based on the modified block data. In one embodiment, multiple index buffers are processed sequentially or in parallel, or interleaved, and the block data for the multiple index buffers is then combined by the host device to generate the factorized output matrix once all of the index buffers have been processed.

The one or more kernels can be created by taking a source code for an algorithm, such as a Cholesky decomposition, and modifying the source code to generate the iBLAS kernels. Kernels are generated for a user-specified set of parameters nb. FIG. 11B illustrates a flowchart of a method 1150 for creating an indexed basic linear algebra subprogram (iBLAS) kernel, in accordance with an embodiment. The method 1150 may be performed by a host device.

At 1152, source code is processed to collect scalar accesses to elements within the input matrix. In an embodiment, the source code can be a program for performing a Cholesky decomposition in a language, such as Python. A compiler interprets the source code to statically execute the instructions in the source code based on various parameters. The parameters can specify, for example, the size of the input matrix and the size of each block.

At 1154, the instructions are inserted into a directed acyclic graph (DAG) in accordance with data dependencies corresponding to the scalar accesses of elements within the input matrix.

At 1156, each instruction in the DAG is associated with a marker that identifies a corresponding block. In an embodiment, the marker can identify an index for the block being processed by the instruction.

At 1158, the DAG is traversed to create a sequence of instructions that minimize a number of load and/or store operations that need to be inserted into the code in order to load block data for the blocks into a register cache of the accelerator device. By optimizing the order of instructions, the number of loads or stores can be reduced in order to decrease the latencies associated with moving data for blocks from the host memory to the register cache of the accelerator device.

At 1160, the instructions are mapped to a register cache. In an embodiment, the register cache is a model for a collective register cache (CoRe) that is an abstraction that allows for the number of parallel executions to be specified at compile time. A separate compiler will eventually map the registers of the register cache to the actual hardware implementation of the register cache in the accelerator device.

At 1162, a modified source code in an intermediate representation is compiled based on the mapping. In an embodiment, the modified source code is an intermediate representation that is not specific to a particular accelerator architecture. A source-to-source compiler interprets the intermediate representation to generate source code for a target architecture corresponding to the accelerator device.

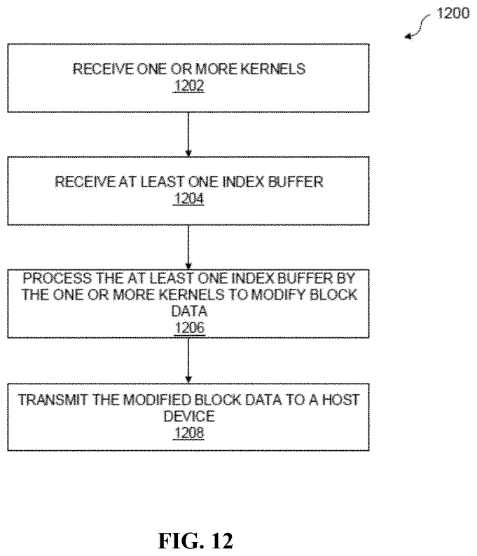

FIG. 12 illustrates a flowchart of a method 1200 for processing an index buffer by an iBLAS, in accordance with an embodiment. The method 1200 may be performed by an accelerator device.

At 1202, one or more kernels (corresponding to one or more values of nb) are received (i.e., made available to) by an accelerator device. The kernels may be stored in a memory accessible to the accelerator device, and may be provided in a binary form (i.e., as executable instructions). In an embodiment, each kernel is an iBLAS kernel generated, e.g., via the method 1150. In an embodiment, the kernels are programs for processing a frontal matrix represented as an index buffer.

At 1204, at least one index buffer is received from a host device. Each index buffer represents a different frontal matrix generated by traversing a block-elimination tree.

At 1206, the at least one index buffer is processed by the one or more kernels to modify block data stored in the register cache of the accelerator device. The instructions of each kernel may perform, e.g., operations on the elements of the input matrix on a block by block basis.

At 1208, the modified block data is transmitted to a memory of the host device. In an embodiment, the kernels include store operations that write to the block data stored in the register cache of the accelerator device. The modified block data in the register cache is then written back to the memory of the accelerator device.

It will be appreciated that the host device operates as a frontend that prepares kernels and index buffers to perform an operation using the accelerator device as a backend for executing the kernels to process the blocks of the input matrix.

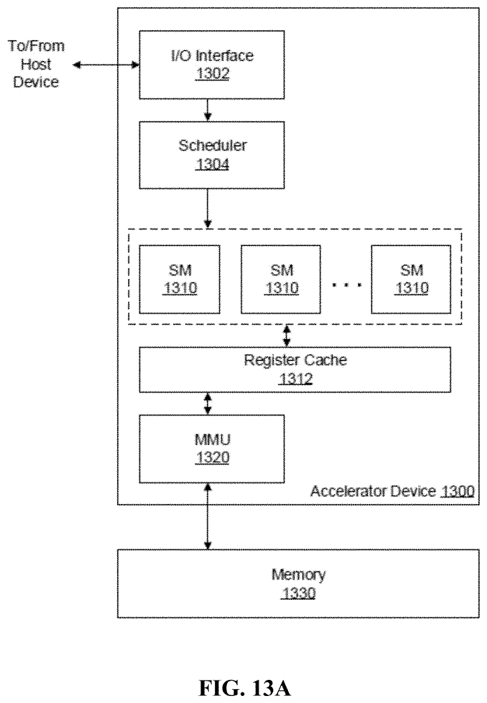

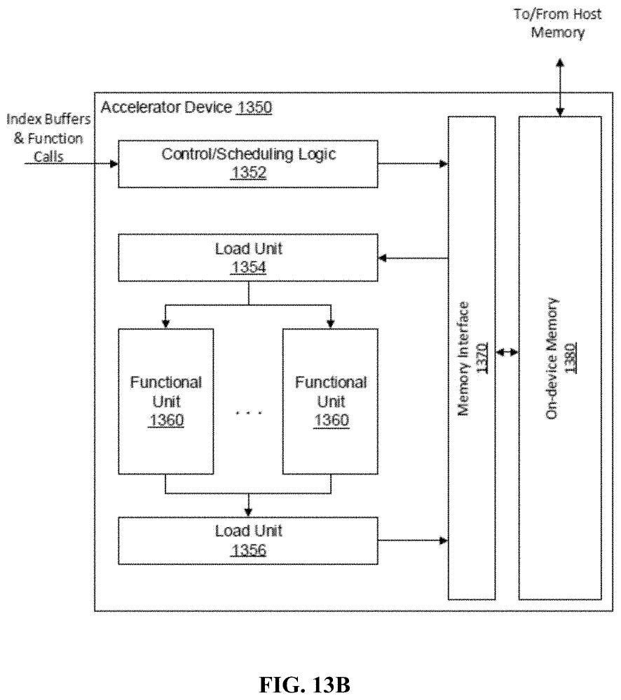

FIG. 13A illustrates an accelerator device 1300, in accordance with an embodiment. The accelerator device 1300 may be, e.g., a graphics processing unit (GPU) that executes multiple threads in parallel in accordance with a single instruction, multiple thread (SIMT) architecture. It will be appreciated that the accelerator device 1300 is merely one such example of a GPU architecture and that other accelerator devices can includes various units in addition to or in lieu of the units shown in FIG. 13A. Furthermore, some units of the accelerator device 1300 may not be shown explicitly in FIG. 13A.

In an embodiment, the accelerator device 1300 includes an input/output (I/O) interface 1302 that can be coupled to a high-speed bus. The host device can communicate with the accelerator device 1300 via the bus, transmitting instructions and/or data over the bus. For example, the kernels and/or block data can be transmitted to the accelerator device 1300 via the bus and processed by the I/O interface 1302.

The I/O interface 1302 receives data via the bus and processes the data to control the operation of the accelerator device 1300. Instructions received by the I/O interface 1302 may be decoded by the I/O interface and forwarded to a scheduler 1304. Data received by the I/O interface 1302 may be stored in a dedicated memory 1380 associated with the accelerator device 1300. Although not shown explicitly, the I/O interface 1302 may also be connected, either directly or indirectly (e.g., via a crossbar or other intermediate unit) with a memory management unit (MMU) 1320 that enables the data received over the bus to be stored in a dedicated memory 1330 accessible to the accelerator device 1300.

Instructions received by the scheduler 1304 may be dispatched to one or more streaming multiprocessors (SM) 1310. The accelerator device 1300 may include a plurality of SMs 1310 that are configured to execute threads in parallel. Each SM 1310 can execute a thread group that processes the same instruction for a number of different threads in parallel for different data stored in a shared memory/register cache 1312. Each SM 1310 may have access to a dedicated portion of the register cache 1312. In some embodiments, at least a portion of the register cache 1312 can be implemented as a shared memory such that data in the shared memory can be accessed by multiple SMs 1310.

Load instructions executed by the accelerator device 1300 can cause data in the memory 1330 to be fetched into the register cache 1312. Similarly, store instructions execute by the accelerator device 1300 can cause data in the register cache 1312 to be written out to the memory 1330. In an embodiment, the SMs 1310 execute the load/store instructions. In other embodiments, a special load store unit may execute the load/store instructions. In an embodiment, a store instruction can also cause the data in the register cache 1312 to be transmitted directly over the bus via the I/O interface 1302 to write the data out to a memory of the host device rather than the memory 1330.

FIG. 13B illustrates an accelerator device 1350, in accordance with another embodiment. Accelerator device 1350 may be, e.g., implemented using a field programmable gate array (FPGA) device.

As depicted in FIG. 13B, the accelerator device 1350 includes a control and scheduling logic 1352 that is configured to receive at least one index buffer and/or function calls via a bus or other communication interface with the host device. The control and scheduling logic 1352 is connected to a memory interface 1370 that allows data and/or instructions to be written to an on-device memory 1380.

A first load unit 1354 is connected to the memory interface 1370 and is configured to read raw block data and function calls from the on-device memory 1380 via the memory interface 1370. The first load unit 1354 then forwards the block data to one or more functional units 1360. The functional units 1360 can be the same, such as to process multiple blocks in parallel, or different, such as to implement multiple functions on the same block data. For example, a first functional unit 1360 can be configured to implement a dense Cholesky factorization on the block data while a second function unit 1360 can be configured to implement a Schur update function on the block data.

The modified block data generated by the functional unit(s) 1360 is then received by a second load unit 1356, which writes the modified block data back to the on-device memory 1380 via the memory interface 1370. Although not shown explicitly, the on-device memory 1380 may be connected to an external memory interface for reading data from or writing data to a memory associated with the host device. For example, raw block data may be read from the memory associated with the host device and stored in the on-device memory 1380, and modified block data in the on-device memory 1380 may be written to the memory associated with the host device. Alternatively, the memory interface 1370 may perform this function, or the control and schedule logic 1352 may implement bi-directional communication over, e.g., a bus or other interface.

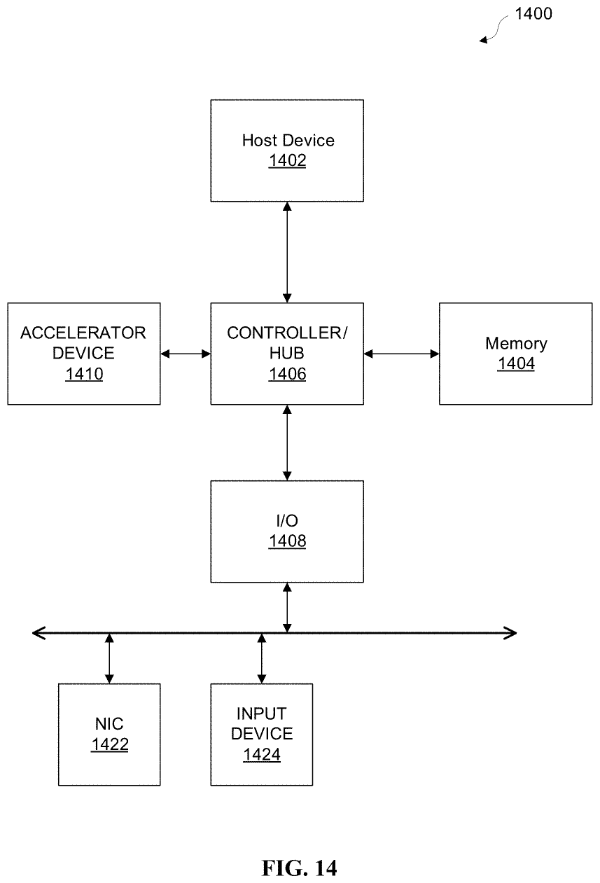

FIG. 14 illustrates a system 1400 for synthesizing zero-copy sparse matrix factorization, in accordance with an embodiment. The system 1400 includes a host device 1402 and an accelerator device 1410. In an embodiment, the host device 1402, which may be referred to as a processor, is a central processing unit (CPU), such as an x86 based processor. The host device 1402 is connected to a memory 1404 via a controller/hub 1406. In an embodiment, the controller/hub 1406 is a Northbridge chip.

The host device 1402 is also connected to the accelerator device 1410 via the controller/hub 1406. In an embodiment, the accelerator device 1410 is a graphics processing unit (GPU) that is connected to the controller/hub 1406 via a high-speed graphics bus. The controller/hub 1406 is also connected to a input/output controller 1408. The input/output (I/O) controller 1408 is connected to a bus, such as a peripheral component interconnect (PCI) bus. Various devices, such as a network interface controller 1422 and/or an input device 1424 (e.g., keyboard, mouse, etc.) can be connected to the bus and communicate with the host device 1402 via the I/O controller 1408.

The system 1400 enables the host device 1402 to operate as a frontend and the accelerator device 1410 to operate as a backend for performing the zero-copy sparse matrix factorization. It will be appreciated that, in other embodiments, the host device 1402 and the accelerator device 1410 can be located remotely in two different systems that communicate via a wired or wireless interface. In one embodiment, the host device 1402 can communicate with the accelerator device 1410 via a network. Furthermore, in some embodiments, the system 1400 can include two or more accelerator devices 1410. In such cases, the host device 1402 can process some index buffers on a first accelerator device 1410 and other index buffers on a second accelerator device 1410, in order to improve on the parallelism of the solution.

### Adaptive Matrix Factorization for Structured Matrices or Mixed Precision Matrices

Embodiments of the present disclosure allow custom formats for each individual block within the matrix. As the block size parameter n represents a tradeoff between memory overhead and symbolic computation/scheduling overhead, it is beneficial to use knowledge of the matrix at hand in order to maximize n without an excessive increase in memory use.

Two examples for this use case include the following.

In many areas of HPC and artificial intelligence (AI), approximate computation and lower precision computations have become a way to gain performance. However, for large matrices, having a single level of precision might not be ideal to represent the numerical properties sufficiently. Hence, in a first use case, a system according to the present disclosure enables users to use higher floating point precision in blocks that are numerically difficult (e.g., with near-zero pivots) and less precision otherwise. In this use case, the load/store operations then convert from the storage precision in the host memory to a potential different working precision in the register cache of the accelerator device.

There are matrices that follow certain patterns in their structure, e.g., so-called “hierarchical” matrices. Such matrices contain row- and column blocks that are of low rank. Hence, in a second use case, such blocks may be represented by a set of k<n vectors. In this use case, the custom load and store operations need to compute a rank-k outer product or do a low-rank decomposition.

It will be appreciated that the load/store operations can refer to a function comprising a plurality of instructions. For example, the load operation can include multiple instructions for computing an outer product. In some cases, the load operation can include a single load instruction defined in an instruction set of a target architecture, such as where the precision of the block format matches the precision of the values stored in the host memory.

Additionally, embodiments of the present invention may include more complex storage formats that require complex load/store operations. In one embodiment, a subset of the blocks containing sparse matrix data may be approximated through a low-rank vector product. In this case, an n×n block is represented by matrices U ∈ [symbol] ^{n×t} and V ∈ [symbol] ^{n×t} whose product forms the block in question. In this embodiment, t<<n and thus the “loading” operation incorporates loading U, V from memory through primitive loading operations and computing the matrix product into the register cache. The “store” operation first performs a low-rank factorization, e.g. through a singular value decomposition, in the register cache and then stores the resulting factors U, V in memory. To the user, this complex set of instructions looks like a single load/store operation. Various block formats are handled transparently.

### Sparse Factorization on the Edge

With the increasing number of devices participating in cellular networks, some computations (especially the kinds that demand low-latency) are moving towards the “edge” of the networks, i.e., the devices themselves. However, these devices are mostly powered by batteries, so computations have to be performed in an efficient way that avoid overly draining the battery. Hence, manufacturers employ systems on chips (SoC), including low-power hardware accelerators for the most frequent computational tasks, e.g., matrix-matrix multiplication accelerators for deep networks in Apple's M1 SoC. Hardware accelerators are often fixed-function; however, in order to achieve low-power computations while still retaining some flexibility, some manufacturers have started to include small FPGAs into their SoCs.

Through the generation of subkernels and their scheduling in batched mode, a system of the present disclosure is able to generate code for these systems as well, matching the pipelined nature of FPGAs. Thus, the systems of the present invention are able to generate code for various scales of computer systems; from HPC clusters to small edge devices.

“Analysis Method and System”, US Patent Application Publication No. 2005/0234686 A1 (the entire contents of which is hereby incorporated by reference herein) discussed an idea for exploiting blocks within a sparse matrix in order to speed up the computation itself. The idea presented in this disclosure handles the situation where a sparse matrix is rank-deficient, representing it through a quad-tree. On different levels of the quad-tree, the implied submatrix is approximated through a low-rank product of sparse rows and columns. Operations using the original matrix are then carried out with the compressed matrix instead.

“Sparse and Efficient Block Factorization for Interaction Data”, US Patent Application No. 2004/0078174 A1 (the entire contents of which are hereby incorporated by reference herein) reports an idea where multiple sender/receiver stations in an antennae simulation are clustered, forming large rectangular blocks in the resulting interaction matrix. When multiple linear systems featuring the interaction matrix need to be solved, the reference proposes using a direct method, i.e., a sparse matrix factorization. Scalar operations inside a, e.g., LU factorization, are replaced by their block-counterparts. In addition to that, the reference proposes that if occurring blocks are large enough, factorization operations on sub-blocks can be relegated to BLAS kernels, implying that these sub-blocks are contiguous and naturally occurring within larger blocks. No further details on the storage format of the block-sparse matrix are given. As an extension in part the preceding, “Sparse and Efficient Block Factorization for Interaction Data”, US Patent Application Publication No. 2008/0097730 A1 (the entire contents of which are hereby incorporated by reference herein) proposes that GPUs can be leveraged in order to either: i) perform multiple operations on the scalar level at the same time; or ii) perform multiple BLAS operations on blocks at the same time.

In the same spirit, “System and Method for Efficient Sparse Matrix Processing”, U.S. Pat. No. 10,296,556 B2 proposes to partition sparse matrices into multiple parts with approximately the same number of non-zero entries. These parts are stored on multiple GPUs and used to compute a sparse-matrix vector product (SpMV) in parallel. Each partition contains an index vector that maps local row indices back to global row indices. However, no block-like or similarly dense structure is used at any stage.

Finally, for the specific case of rank-deficient matrices, “Analysis Method and System”, US Patent Application Publication No. 2005/0234686 A1 (the entire contents of which are hereby incorporated by reference herein) outlines a method where low-rank blocks in a sparse matrix are approximated through low-rank products. The approximated blocks are organized within a quad-tree. A factorization of the rank-deficient matrix is replaced by a factorization of the approximated matrix.

Embodiments of the present disclosure improve over the presented state-of-the-art in various ways. For example, embodiments support: i) unstructured matrices from various problem areas; and ii) multiple kinds of accelerator architectures. Furthermore, embodiments iii) create virtual dense matrices from scattered blocks dynamically, without the assumption of naturally occurring, dense block structures. Additionally, embodiments vi) employ an automated compilation process that allows the cross-accelerator use of various block formats and removes the dependency on vendor-provided, fast BLAS implementations.

Other than US 2004/0078174 A1 or US 2005/0234686 A1 that assume a problem-driven, higher-level clustering of entities that result in a block-sparse matrix structure, embodiments of the present invention employ a preprocessing that aims to discover blocks in unstructured matrices while minimizing fill-in and maximizing parallelism. Furthermore, embodiments of the present invention regard the block as an atom in the later stages of the computation instead of further dividing it up into sub-blocks of smaller size. Through that, embodiments of the present invention are able to dynamically “abstract” blocks into a larger matrix. Together with aspect (vi) (automated compilation), this principle allows embodiments of the present invention to operate without additional buffers even when dense structures are not occurring naturally.

As a previous study, “Flynn's reconciliation: Automating the register cache idiom for cross-accelerator programming”, D. Thuerck et al, ACM TACO 2021, has shown, the concept of processing small blocks in scratchpad memory (“warp register cache”) results in highly performant kernels across a large variety of accelerator devices. Embodiments of the present disclosure extend this from small, dense factorizations to sparse matrix factorizations.

As a result, embodiments of the present invention cover a wider range of accelerators and heterogeneous systems than just GPUs.

In US 2004/0078174 A1, US 2005/0234686 A1, and U.S. Pat. No. 10,296,556 B2 dense computations using BLAS-kernels rely on the presence of large, dense blocks—or sparse blocks that are “dense enough”. In order to use a BLAS kernel, this sparse data either needs to be copied into an allocated buffer or it is stored already in a large, contiguous and dense panel. Embodiments of the present invention allows scattered storage of blocks that make up a matrix through the compilation process (i.e., automated compilation). At the same time, this allows for heterogeneous storage formats, where each block of a larger matrix is stored in a specific data format. As an example, these blocks may be stored with various degrees of floating-point accuracy.

The compilation process of embodiments of the present disclosure creates kernels that operate like BLAS kernels, but do not need a contiguous buffer containing the matrix under processing. Rather, an overlay data structure is used, and blocks comprising the matrix are loaded into scratchpad memory when necessary. Through an optimization pass, the number of such load/store operations is minimized. Furthermore, following the principles outlined in “Flynn's reconciliation: Automating the register cache idiom for cross-accelerator programming”, D. Thuerck et al, ACM TACO 2021, code for various accelerator architectures can be generated. This removes the dependency from vendor-supplied code and helps users that try to leverage the power of their heterogeneous systems. As a byproduct, since sparse matrix factorization is often a bottleneck in scientific codes, embodiment of the present invention help mitigate these bottlenecks by freeing up CPUs during the factorization that would otherwise need to (re)assemble frontal matrices in multifrontal codes.

More specifically, as disclosed in Thuerck et al., a common virtual accelerator architecture is disclosed. The warp register idiom of CUDA (a C++ extension used with NVIDIA GPUs) binds the programmer to warps with 32 threads, which is clearly specific to the NVIDIA's architecture, limiting the portability of the warp register idiom to different architectures that, e.g., include a different number of threads in each thread group due to the number of parallel processing units implemented in the processor. A collective register cache (CoRe) idiom can be defined by simply removing this limitation, and instead allowing a configurable size for the number of threads in each thread group. For instance, in code processing 3×3 matrices, a thread group having 3 threads can be selected, and the threads in the thread group can share the input matrix collectively. With the idiom defined, we now need a way to map it to different models, i.e., SIMD and SIMT.

While SIMT and SIMD share similar concepts, their programming models are different. In the SIMT-implementation for CUDA, algorithms from the perspective of a single thread are implemented, and the warp-based execution model provides implicit vectorization. For SIMD systems, both assembly and C with intrinsics use fixed-width vectors as a data type (i.e., explicit vectorization). Thus, their respective intermediate representations are also designed in different contexts. A prime example is the compiler gpucc where host (i.e., x86 processor, including SIMD) and device (i.e., GPU) code each have a respective intermediate representation.

As a common abstraction over the two models within the context of batching, Thuerck et al. proposes PIRCH (the Partitioned Infinite Register maCHine), a theoretical architecture that offers a well-defined representation from which both SIMD and SIMT codes may be extracted. In a nutshell, PIRCH can be described as SIMT-on-SIMD.

The PIRCH architecture is designed with batched kernels in mind. Assuming that batch items do not interact, all batch items may be, theoretically, run concurrently. As the batch size is not known until runtime, the amount of data stored in registers cannot be bound a priori.

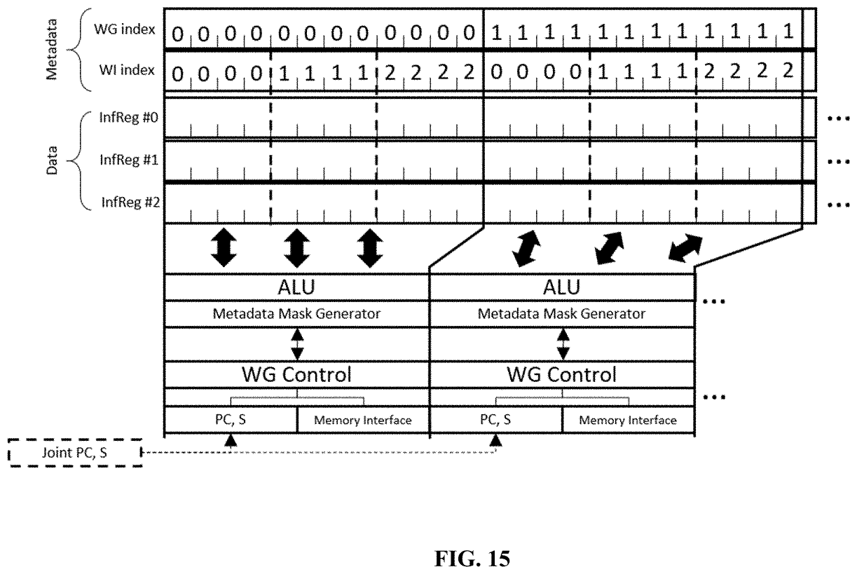

FIG. 15 illustrates the theoretical PIRCH architecture, in accordance with an embodiment, which can best be described as a “SIMT-on-SIMD” concept. While InfRegs and vector ALUs resemble a SIMD model, the partitioning into WGs and WIs follows the SIMT paradigm. Moreover, metadata can be used in computations to generate vector masks, implementing SIMT-like divergent control flow between WIs within the same WG. A per-WG shuffle unit implements the shuffle primitive similar to CUDA's warps. All WGs execute independently from others with their own control units. When the amount of divergent execution between WGs is low, they may optionally use a common program counter. Last, these control units share an infinite amount of main memory from and to which they can issue WG-sized vector loads and stores.

In the execution model, the PIRCH architecture deviates from the typical fixed-size warp scheduling model. Instead, the whole WG is executed, independent of its size, as if it was one warp, in lockstep without explicit synchronization, and shuffle instructions are used (without support for sub-warp masks) to exchange data between WIs. Therefore, the term “wavefront” may refer to the now equivalent “WG” and denotes the compile time-constant wavefront size as WG_SIZE.

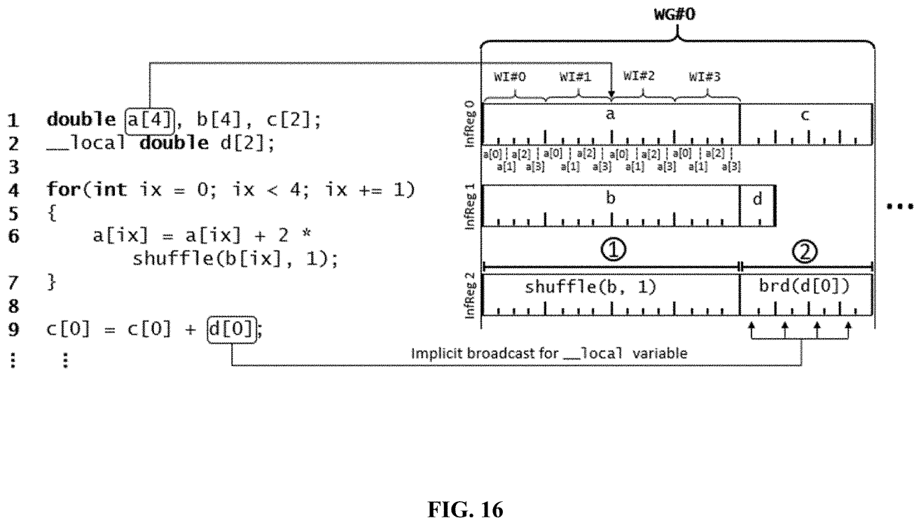

To be able to follow the CoRe idiom, the PIRCH architecture proposes to use OpenCL C extended by a shuffle instruction as an input language. PIRCH's mapping of variables to InfRegs follows five rules: (1) each private variable (arrays) is concatenated WG-wise into a single InfReg whereas (2) local variables are only held once; (3) Variables that interact must be aligned to the same lanes, leading to a partitioning into interaction; (4) Variables with non-intersecting liveness ranges and compatible type may be assigned to the same InfReg and lanes; and (5) reordering InfReg lanes within an WG triggers implicit broadcasts, whereas cross-WI data exchange requires a shuffle instruction. Last, to compute multiple batch items in a single run, the area marked as “WG #0” may be repeated horizontally. FIG. 16 illustrates the mapping of an OpenCL program fragment to PIRCH registers, in accordance with an embodiment.

The PIRCH architecture draws on the experience from current SIMD systems where interactions between different lanes are costly, but interactions between two vectors within the same lane are cheap. Notably, there is only a unique association from program variables to InfRegs, but not vice versa. While, in theory, every lane in an InfReg may have different scalar types, we limit this to one common scalar type per InfReg to facilitate the mapping to actual hardware.

The PIRCH architecture subsumes both SIMT and SIMD, but mapping to a target architecture requires specializing for either at some point. When encoded properly, the PIRCH architecture can be seen as an intermediate representation (IR) in a cross-accelerator toolchain for batched kernels. As follows, the disclosure describes an encoding in the form of a textual IR. While many typed IRs can be used to encode programs using PIRCH, in an embodiment, the broadly adopted LLVM IR is extended and used for PIRCH. LLVM IR is a single static assignment (SSA)-based, typed low-level representation.

As all WGs in PIRCH are independently scheduled units and only depend on their metadata, it is sufficient to represent a single WG's computation and parameterize it by metadata. As LLVM offers a flexible system for the definition of custom metadata, PIRCH's metadata can be represented in addition to the computation.

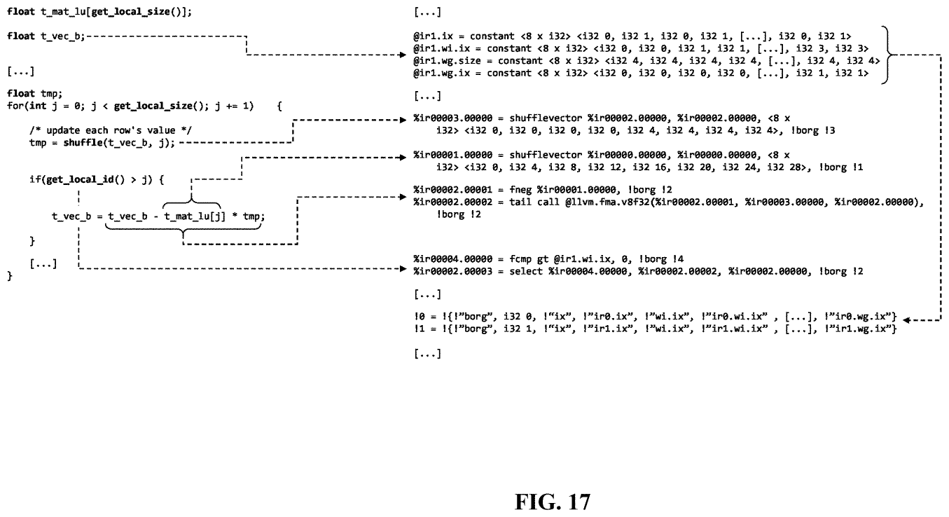

FIG. 17 shows an example intermediate representation (IR) for a fragment of kernel code, in accordance with an embodiment. In line with the mapping rules outlined above, a variable such as t_vec_b in line L2 of Example 1, maps to an InfReg, triggering the creation of constant vectors in the IR (R1-R4) for its associated InfReg #1 (ir1). These constant vectors may also be references in computations (R9). When multiple WGs share one program counter, vectors are concatenated such that the IR then represents the computation of these WGs. In this case, only the first WG in each kernel receives its global index as an argument and we add local constant WG offset (R4) onto it to determine the global indices of all participating WGs. In Example 1, we set WG_SIZE to 4 and share a program counter between pairs of WGs. For scalar variables such as t_vec_b, this results in a size for the InfReg chunk of WG_SIZE×1×2=8.

These vectors are collected in LLVM metadata nodes (R11, R12), each representing the metadata for one InfReg, associating keywords ix, wi. ix, wg.size, wg.off, wg.ix with the respective constant vectors or, in case of wi.ix, the runtime-computed values. Any instruction that creates an SSA-value representing an InfReg's state is annotated by the respective metadata nodes. The scalar types of InfRegs are implied through the types of LLVM's operations, e.g., f32.

Mapping the so-modified LLVM IR to SIMD processors is straightforward. However, for SIMT systems, we have to enforce location constraints: Two lanes of vector types may interact only if they share the wi.ix. The only notable exception here is the LLVM IR instruction shufflevector to which PIRCH's shuffle maps (R6). By evaluating the metadata in the lanes of metadata node !2 corresponding to InfReg #2, a shuffle pattern is reconstructed. R5's shuffle pattern corresponds to a broadcast from WI 0 to all other WIs.

In one embodiment of a source-to-source compiler, borG, only a subset of LLVM instructions is implemented: arithmetic operators (fadd, fsub, . . . ) and the comparison operator fcmp including integral forms; FMA-intrinsics; load and store and gather/scatter intrinsics where applicable; select for masked computations, branching instructions and phi nodes. Pointers are dereferenced with getelementptr. By following the principle of appending InfReg metadata nodes in LLVM IR, the remaining parts of LLVM IR may be added when needed. Alternatively, the modified LLVM IR may be implemented as a dialect of MLIR, a multilevel framework for defining and transforming IRs. This modified LLVM IR framework may be referred to as “Infreg-IR.”

The borG Compiler

Developing even rather short and simple kernel codes can require tremendous effort when multiple target architectures and programming models have to be considered. In an embodiment, a borG compiler is disclosed, which is a source-to-source compiler that automates the mapping from batched kernels written in OpenCL C to multiple accelerator backends via PIRCH IR. The borG compiler can generate code for CUDA, SX-Aurora, and AVX512 as well as emit LLVM-IR. Using borG extends device support for systems relying on batched kernels immediately while saving developers a considerable amount of time.

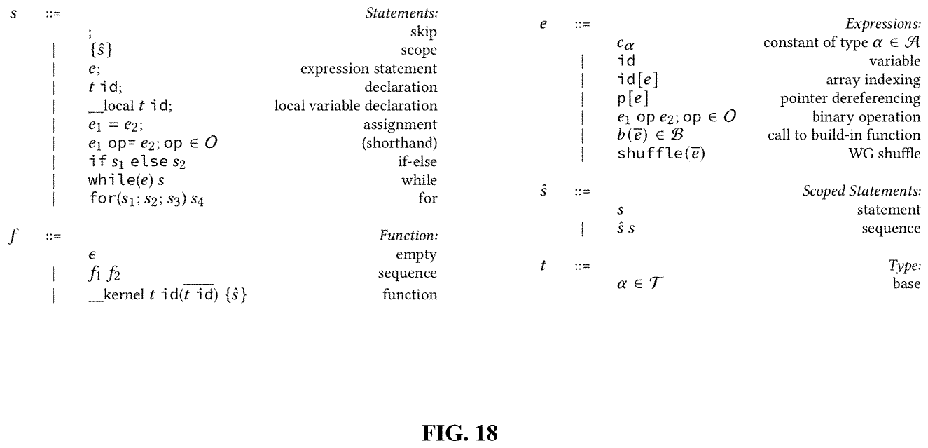

To map the IR to actual hardware, implementing the PIRCH model with its infinite registers is not possible and assuming a maximum batch size is undesirable. However, the batches may be processed in arbitrary order. The borG compiler exploits this arbitrary ordering to generate code that deals with a limited set of batch items and then uses platform capabilities, e.g., OpenMP loops, to repeatedly call the generated kernel with changing metadata. The borG compiler's frontend consumes a subset of OpenCL C as defined by the grammar shown in FIG. 18. In an embodiment, the borG compiler supports all standard primitive C types and the OpenCL C functions [symbol] ={get_local_id, get_group_id, get_local_size, sqrt, max, min, abs, rcp}.

Arrays are passed as pointers into borG kernels. These pointers can be dereferenced and indexed by constant or runtime values, but further pointer arithmetic has not been implemented yet. Moreover, in an embodiment, the borG compiler does not support structs. These are not limitations of the concept. Rather, warp-cache implementations for GPUs favor the “Structure of Arrays” memory layout for performance reasons, which is covered by the subset of grammar implemented by the compiler. Many interesting cases are covered by this subset of OpenCL C. However, adding support for both features would be possible, in other embodiments. Structs may be either packed into the same InfReg with its members in adjacent lanes or distributed over multiple InfRegs with one InfReg per struct member. Pointers can be added as a datatype in InfRegs. On SIMD platforms, dereferencing these pointers without further analysis then leads to gather and scatter instructions

The PIRCH architecture offers the option to steer multiple WG's executions from a single PC (program counter) and stack when the expected divergence is low. In the finite setting of borG, this translates to kernels that process multiple WGs in one call. This feature is especially useful for small batch items, e.g., 3×3 matrices, that would otherwise not fill the (SIMD) registers. As used herein, the factor WG_PACK can be used to express how many WGs are processed in one kernel call. Furthermore, these WGs can be referred to as one “pack.” Within the pack, a WG's global index is then the sum of the index of the pack plus the WG's local offset within the pack. WG_PACK is exposed to the user as a tunable parameter, compromising between register pressure within a kernel and the overhead of launching kernels.

PIRCH and borG were designed with batched kernels in mind, assuming independence of all batch items. In addition to that, in one embodiment, borG strictly follows the PIRCH model, not offering any means of communication between different WGs. A generalization to general-purpose code would require two extensions. First, it would mandate adding capabilities for communication and synchronization between WGs. This could be done by, e.g., adding support for atomic instructions, mutexes, or other forms of resource sharing in borG. Second, borG's language can be extended to support structs and functions to cover a larger subset of OpenCL C and enable recursion. The required changes are conceptually minor, but may complicate the mapping from variables in the front-end to InfRegs and make the mapping opaque for developers. The current restrictions on borG thus are not conceptual, but should enable users to maintain a high level of control on their code while still covering a large-enough set of important batched kernels.

The borG Frontend

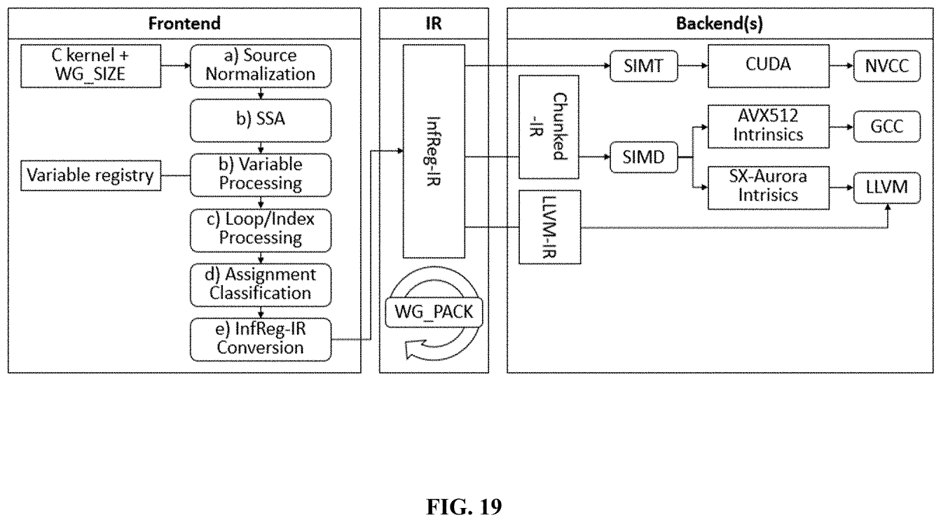

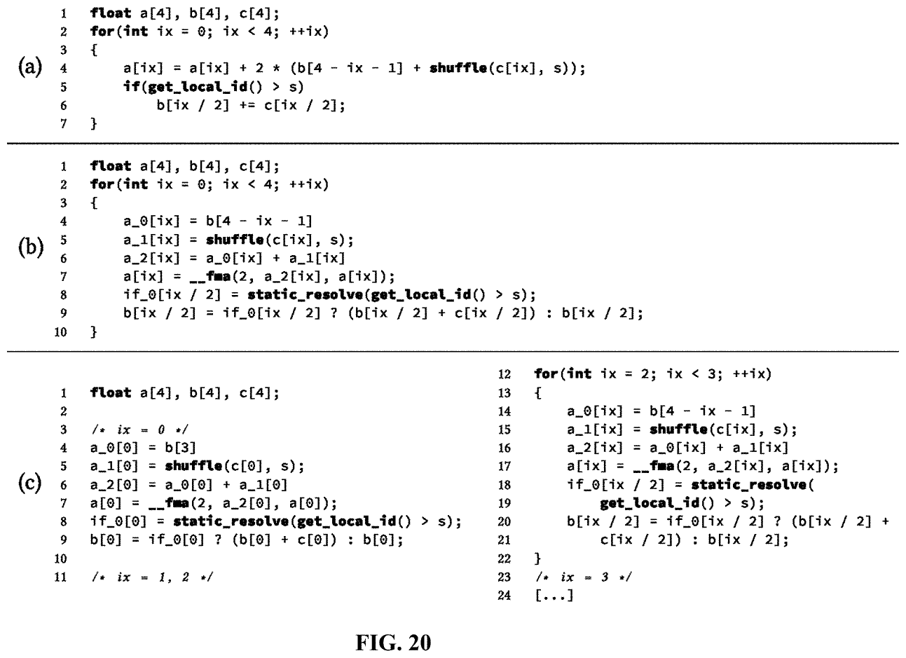

The borG compiler's frontend consumes the kernel code using PyCParser and a WG configuration (WG_SIZE, WG_PACK) and generates a kernel description in InfReg-IR. Given an OpenCL C-file, the frontend parses all functions with a _kernel annotation. As depicted in FIG. 19, the borG compiler's frontend executes a sequence of code transformations on the abstract syntax tree (AST). Example 2, as depicted in FIG. 20, shows the different steps of the code transformations where listing (a) represents the input code.

To facilitate source code processing downstream, all scalar variables are promoted to array variables of size 1 and an index [0] is added to all accesses. Furthermore, all combined assignments (e.g., +=) are expanded into their full expressions and the conditions in ternary operations are moved into if-blocks. Last, all variables are collected with their respective (scalar) types and dimensions and classified as explicit variables.

Similar to most compilers, a SSA decomposition is performed on each assignment in the code, leaving only elementary operations on the right-hand side; all resulting assignments are placed in a single code block. For each additional assignment, a copy of the variable is instanced on the left-hand side of the original assignment that is local to the generated block. The local variables are marked as implicit. Due to PIRCH's requirements on cross-lane operations and the restriction to compile-time array indices, the SSA decomposition is extended as follows.

Array indices for the variables on the left- and right-hand sides are compared symbolically using SymPy. If symbolically different indices are encountered, then this results in an additional assignment for variable reordering being generated. Similarly, any calls to shuffle, another type of cross-lane operations in the InfReg down the road, imply an additional assignment. For each if- and else block, Boolean array-valued variables are created that are used as masks. All masks—one instance per compatible IR-format of variables that appear in the conditional's body—are then propagated to assignments as conditionals in ternary operations. Last, whenever a matching pattern is encountered in the AST, FMA-type operations are inserted automatically. After this step, the code of our running example has been transformed into listing (b) in Example 2 of FIG. 20.

All implicit and explicit variables are extracted and assigned unique global IDs. Then, all variables that interact with each other, i.e., appear in the same assignment, are gathered into a matrix. By interpreting this matrix as a graph and extracting connected components, interacting sets of variables are determined. Two variables from different sets may be packed into the same lanes in an InfReg. Variables inside the same set must be packed into different InfRegs, but aligned to the same lanes. All variables are packed into InfRegs in a greedy manner, packing the independent sets horizontally into each InfReg. Last, all lanes are annotated with their respective WI IDs.

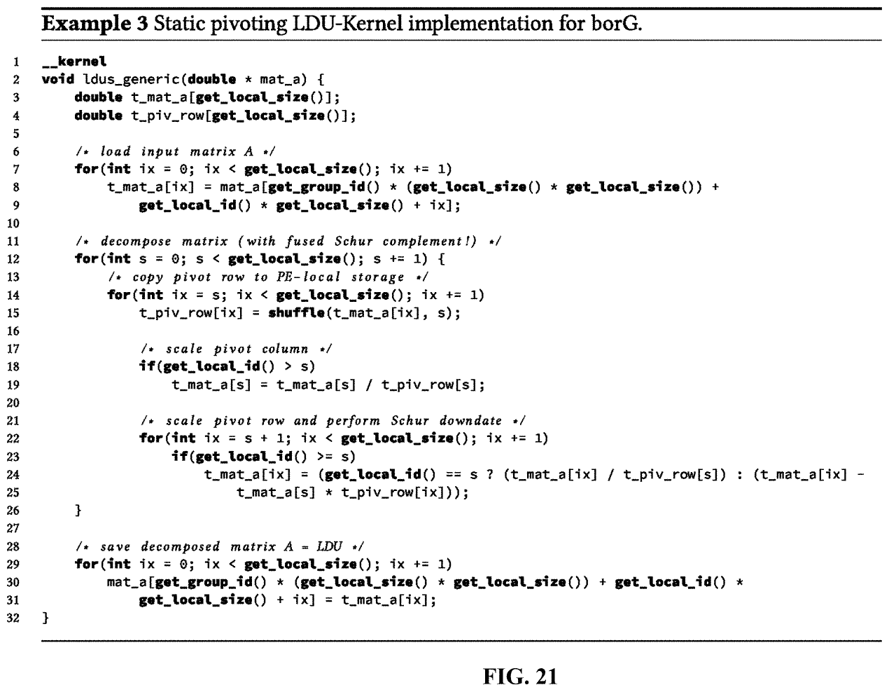

Kernels following CoRe can contain WI-local arrays, e.g., t_mat_a in Example 3, as depicted in FIG. 21. Each lane of an array is mapped to registers, hence their indices must be resolved at compile time. When arrays are accesses in the body of a for-loop, that loop is first classified into one of three categories: unroll, vectorize, and runtime. If the loop index depends on a runtime variable, then all instructions inside the loop's body are predicated with a mask that deactivates all lanes of WIs that have already left the loop. At runtime, the loop is executed until all WIs evaluate the loop condition to false. In case of nested for-loops, all outer loops are unrolled. Otherwise, their indices are evaluated in borG and the values are propagated to array accesses in the loop body. Here, the loop's counter variable is iterated over sequentially and index sets are determined that could be processed within a single instruction (“vectorize”). As an example, compare lines 6 and 8 in Example 2's listing (b): for ix=[0, 1, 2, 3], line 6 leads to indices [0, 1, 2, 3] on the left-hand side, so all lanes used in these loops may be processed in a single instruction. Line 8 leads to [0, 0, 1, 1]. To avoid write conflicts, the loop is split progressively into index sets [[0], [1, 2], [3]]. As long as there are no dependencies on earlier iterations of this loop, the split index set can be optimized by reordering iterations, leading to [[0, 2], [1, 3]]. Without this type of analysis, SIMD units would be dramatically underutilized. The resulting code after splitting is given in listing (c) of Example 2 of FIG. 20. In doubt, e.g., when an array index depends on the loop variable of a runtime-for, a loop is executed sequentially, i.e., with one array member per WI processed per iteration instead of the whole array in a single iteration. When array indices cannot be determined at compile time, the whole array is temporarily stored in memory and accesses for the current instruction are mapped to gather/scatter instructions, leading to drastic performance losses.

In an optional frontend pass, index expressions are analyzed for memory accesses using SymPy. The expression should be expressed as a polynomial on a work item's local and global ID, if possible. Based on that analysis, it is determined whether an access is contiguous and a scalar offset is extracted for contiguous loads and stores.

Additionally, a streaming option is offered to limit register pressure. With this option enabled, data is always loaded from memory upon access and written back after each update. For that, the results of the last symbolic memory access analysis are stored and turned into an InfReg↔memory mapping.

Remaining loops in the transformed C code are unrolled into separate IR nodes at this stage, resulting in a doubly-linked list of nodes that are then converted into InfReg-IR. As last step, multiple WG instances are packed into the InfRegs as described before, which then automatically expands all IR instructions to processing multiple WGs. The resulting IR is then handed off to one of the backends.

The borG Backends

Various backends can be implemented for different target architectures. As described further herein, the backends can include, but are not limited to, a SIMT backend, a SIMD backend, and an LLVM backend.

SIMT Backend: The SIMT backend generates CUDA-C++. To match the hardware warp size, the WG_SIZE is restricted to ≤32 and the GPU's hardware shuffle functions are leveraged in lockstep execution. The crucial point in this backend is the decomposition of InfReg-IR computations into execution groups, i.e., groups of CUDA threads inside a warp that execute the same code. The WIs are partitioned into active sets according to the InfReg lanes that they access or, if specified, mask. Each groups' code is predicated using a condition such as ((1<<wi_ix) & 0x02) where wi_ix corresponds to the WI's index in InfReg metadata. A groups' code is serialized in case of diverging accesses, as in the case for b in a [0]=a[0]/b[wi_ix]. Here, b's index varies per WI, thus every WI is its own execution group. Consequently, all WIs are serialized, resulting in code resembling the following extract (for WG_SIZE=2):

if (wi_ix==Ø)aØ=a_Ø/b_Ø;

if (wi_ix==1)a_Ø=a_Ø/b_1;

If WG_PACK is set to a value >1, then the whole WG code is replicated and references to the work group index are updated by the pack's local WG offsets. Reordering, shuffles, and ternary operations all map natively to the scalar CUDA language. The shuffle and reordering patterns are inferred from the InfReg-IR by analyzing the lane permutation vectors. While WI-local variables are mapped to registers, WG-wide shared variables are put into the GPU's local memory. Furthermore, the cooperative groups-API offered by NVIDIA is used to handle WG_SIZES≤32. CUDA blocks of size 32 are launched, potentially processing multiple WGs with packing. On NVIDIA GPUs, Streaming Multiprocessors (SM) can only hold a limited number of both blocks and warps in their warp schedulers to perform hardware multithreading. Due to the 1:1 mapping between blocks and warps, the code may be limited by the minimum of both constraints, where in practice the number of held blocks per SM is the lower of both. However, since InfReg lanes are mapped to registers, register pressure turns out to be the limiting factor for occupancy, not the limit on schedulable warps. This was confirmed through experiments where larger, multi-warp CUDA blocks did not exhibit a noticeable performance benefit.

In Example 3, line 8, as depicted in FIG. 21, the WI-private arrays t_mat_a contain a matrix in row-wise format. Iterating over the WI's IDs and then ix leads to contiguous indices into the InfReg for SIMD accesses. On GPUs, this causes all work items to load one member of its t_mat_a per instruction, leading to non-coalesced loads with a stride of WG_SIZE doubles. Ideal register-cache kernels have a high ratio of data reuse, hence fetching the data once in a suboptimal fashion has negligible impact. In fact, e.g., loading a matrix in col-major format when it is held as row-major in memory leads to strided, respectively, interleaved memory accesses. Optimizing these accesses for CPUs with SIMD units or DSPs with indirect vector register files that allows on-the-fly reordering of vector registers is implemented in some embodiments. Thus, one strategy could be to optimize the CoRe kernel code for the GPU's memory access layout and minimize the resulting strided memory accesses on the CPU to avoid changing data layouts of the application. However, this is beyond the scope of the present disclosure.

Except for dead code elimination and memory analysis, the SIMT backend does not currently perform any optimizations on the IR or native code level. Since these optimizations can be very architecture-dependent and we only compile to the source (or IR) level, optimizations performed in the native compilers can be relied on instead of performing optimizations in the borG backend.

It will be appreciated that, with the Volta generation of GPUs, NVIDIA relaxed the lockstep execution within warps. Every thread now has its own state, represented by a PC and stack, and instructions from divergent threads can be interleaved. This means that, e.g., if two threads execute the same _shfl_sync command, then they may do that at different points in time. Hence, NVIDIA's warp-level primitives now include bitmasks that determine all threads that block at the respective _shfl_sync, giving users finer-grained control over synchronization on the sub-warp level. The PIRCH architecture, to maintain compatibility with SIMD execution, only uses one state per WG. Therefore, borG's SIMT backend emulates the pre-Volta mode of lockstep execution by inserting warp synchronization primitives and appropriate masks where applicable to ensure correctness. As a consequence, in an embodiment, architectures supporting thread-independent scheduling may not be fully exploited by borG, potentially resulting in a performance penalty. As borG's main focus is its portability, an extension of borG, in other embodiments, to accommodate this model would require representing the WI's state in InfRegs, adding masks to the shuffle functions as well as modifications to the SIMD backend. However, this is beyond the scope of the present disclosure.

SIMD Backend: The initial mapping from InfReg-IR to SIMD-based ISAs proceeds by splitting arbitrary-length IR vectors into pieces in the native vector length, which may be referred to herein as chunks. This is possible due to the packing constraints enforced by the frontend after SSA'ing the input code. Again, all interacting data in InfRegs are aligned to the same lanes; re-orderings have been processed in an earlier assignment and the resulting implicit variable is aligned in its InfReg as well. A common “SIMD” backend is implemented for AVX512 and SX-Aurora and only the configuration of scalar type-specific native vector lengths and primitive mappings from IR operations to vendor-specific C intrinsics is specialized. Memory accesses use the analysis from the frontend part and are either mapped to contiguous load and store calls or gather/scatter instructions.

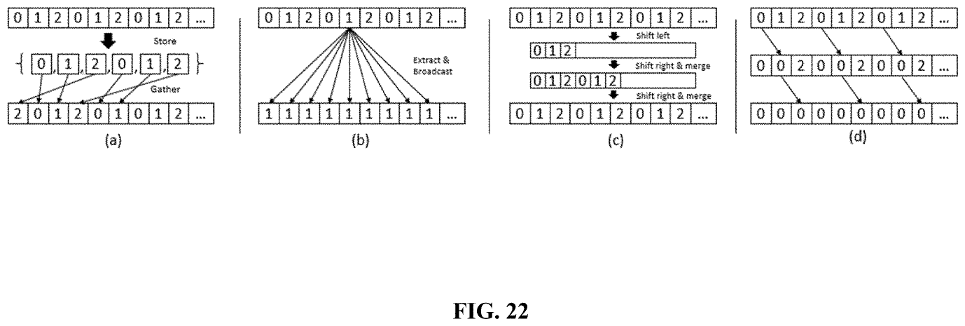

CUDA kernels following the warp register cache idiom often use an approach where each thread stores only parts of the problem's input data in its registers and uses shuffles to access other threads' data. Mapped to InfRegs, this approach leads to a high number of undesirable cross-lane operations. By default, such operation defaults to issuing a store and a gather call to permute the lanes contents. An analysis of the AVX512 and SX-Aurora instruction sets has resulted in three techniques mirroring useful shuffle patterns in CUDA (see FIG. 22):
Scalar broadcast: a[ix]=shuffle(a[0], 2),
Vector broadcast: a[ix]=shuffle(a[ix ], 2), and
Segmented scalar broadcast: a[ix]=a[0].

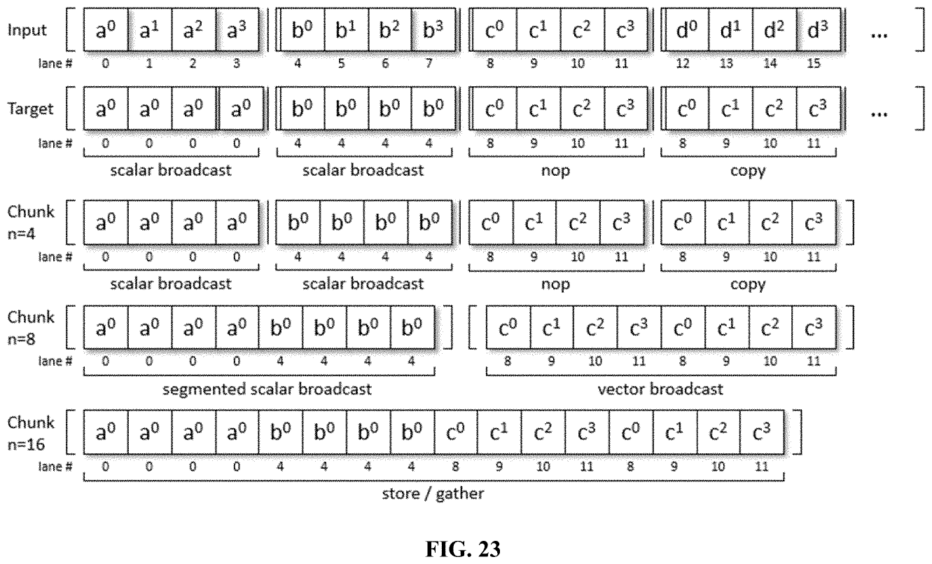

Each of these methods works within one native register. Interestingly, the length of chunks covering an InfReg can make a striking difference regarding which method is selected, as evident from FIG. 23. In practice, shorter vectors see more scalar broadcasts, longer vectors more vector or segmented scalar broadcasts.

LLVM Backend: The simplest among the backends is the LLVM backend. Given InfReg-IR, the LLVM backend outputs LLVM-IR that may then be compiled for all architectures supported by LLVM, such as x86, ARM, or AVX512. Converting from InfReg-IR to LLVM-IR only drops the !borg metadata. With the exception of masked scatter and gather, LLVM intrinsics are avoided (as they are not supported across all architectures) and the backend uses sequential emulations. In some cases, the LLVM backend recognizes these and generates vectorized code. Chunking and implementation selection is left to the LLVM backend.

In the past, several variants of hardware accelerators for sparse data have been proposed—e.g., “Programmable coarse grained and sparse matrix compute hardware with advanced scheduling”, US Patent Application Publication No. 2021/0035255 A1 and “Programmable coarse grained and sparse matrix compute hardware with advanced scheduling”, U.S. Pat. No. 10,186,011 B2 (the entire contents of each of which are hereby incorporated by reference herein). Here, sparse data is loaded through a “data management unit” (DMU) which accesses both high-bandwidth and low-latency memory. The sparse rows or columns can be loaded together as a “block” in order to restrict the range of scattered accesses within a SpMV operation. However, the architecture is limited to computing dot-product like operations with limited programmability. An extension to a matrix factorization is all but trivial. However, in the framework of embodiments of the present disclosure, these accelerators may be used to compute some of the block-kernels, synthesizing them as needed.

Embodiments of the present disclosure offer a way to quickly instantiate efficient code covering a crucial HPC building block on various accelerator architectures with minimal developer involvement. The resulting code and executable avoids introducing latencies between host and device that lead to higher runtimes.

Embodiments of the present disclosure may be implemented into the HPC and AI fields, enabling better exploitation in highly integrated systems. Similarly, the software generated by embodiments of the present disclosure may be used in 5G systems and may help with offloading traffic in the network through edge computations. The embodiments of the present disclosure are capable of automatically generating software that can be bundled with other systems.

Significant engineering effort would be needed to duplicate the full system stack, including re-implementing a compiler such as borG, as disclosed above. So far, no other method is known for sparse linear algebra that can avoid additional buffers.

While the subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, which may include any combination of features from different embodiments described above.

The terms used herein should be construed to have the broadest reasonable interpretation consistent with the overall description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for synthesizing zero-copy sparse matrix factorization operations, the method comprising:
dividing, by a host device, an input matrix into a plurality of blocks stored in a memory, wherein the input matrix comprises a sparse matrix including zero values and non-zero scalar values and each block in the plurality of blocks represents a portion of the sparse matrix that includes at least one non-zero scalar value;
generating at least one index buffer that includes pointers to the blocks in the memory, wherein each index buffer represents a frontal matrix associated with a matrix decomposition algorithm;
receiving one or more kernels configured to process the at least one index buffer on an accelerator device;
transmitting the plurality of blocks to a memory of the accelerator device;
transmitting the at least one index buffer to the accelerator device;
receiving modified block data from the accelerator device responsive to the one or more kernels being executed by the accelerator device for the at least one index buffer; and
generating a factorized output matrix based on the modified block data.

2. The method of claim 1, wherein the dividing the input matrix into the plurality of blocks comprises processing the input matrix via at least one permutation operation such that a number of blocks containing non-zero scalar values is minimized.

3. The method of claim 1, wherein the plurality of blocks comprise a first block associated with a first format and a second block associated with a second format that is different than the first format.

4. The method of claim 3, wherein the first format corresponds to a first load procedure that loads a non-zero scalar value in the first block from the memory of the accelerator device to a register cache of the accelerator device in accordance with a first precision and/or a first store procedure that stores the non-zero scalar value for the first block in the register cache to the memory in accordance with the first precision, and wherein the second format corresponds to a second load procedure that loads a non-zero scalar value in the second block from the memory of the accelerator device to the register cache of the accelerator device in accordance with a second precision and/or a second store procedure that stores the non-zero scalar value for the second block in the register cache to the memory in accordance with the second precision.

5. The method of claim 1, wherein the one or more kernels are generated by compiling code in an intermediate representation to generate the one or more kernels for the accelerator device.

6. The method of claim 5, wherein the code comprises indexed basic linear algebra subprogram (iBLAS) kernels in an low level virtual machine intermediate representation (LLVM-IR).

7. The method of claim 1, the method further comprising:
processing source code to collect scalar accesses to elements within the input matrix resulting from execution of instructions in the source code;
inserting the instructions into a directed acyclic graph (DAG) in accordance with data dependencies corresponding to the scalar accesses to the elements;
associating each instruction in the DAG with a marker that identifies the block corresponding to the instruction;
traversing the DAG to create a sequence of instructions minimizing a number of load and/or store operations;
mapping the instructions to a register cache; and
compiling a modified source code in an intermediate representation based on the mapping, wherein the modified source code includes load and/or store operations that reference the at least one index buffer.

8. The method of claim 7, wherein the register cache comprises a collective register cache (CoRe) model that defines a plurality of infinite registers, and wherein multiple variables with non-intersecting liveness ranges and compatible type can be mapped to a single infinite register and different variables that interact are mapped to a particular lane of different infinite registers.

9. The method of claim 1, wherein the accelerator device comprises at least one of a graphics processing unit (GPU), a tensor processing unit (TPU), a systolic array, a field programmable gate array (FPGA), or a vector processor.

10. A system comprising:
a memory storing an input matrix; and
a processor coupled to the memory and configured to:
divide the input matrix into a plurality of blocks stored in the memory, wherein the input matrix comprises a sparse matrix including zero values and non-zero scalar values and each block in the plurality of blocks represents a portion of the sparse matrix that includes at least one non-zero scalar value,
generate at least one index buffer that includes pointers to the blocks in the memory, wherein each index buffer represents a frontal matrix associated with a matrix decomposition algorithm,
receive one or more kernels configured to process the at least one index buffer on an accelerator device,
transmit the plurality of blocks to a memory of the accelerator device,
transmit the at least one index buffer to the accelerator device,
receive modified block data from the accelerator device responsive to the one or more kernels being executed by the accelerator device for the at least one index buffer, and
generate a factorized output matrix based on the modified block data.

11. The system of claim 10, wherein the plurality of blocks comprise a first block associated with a first format and a second block associated with a second format that is different than the first format.

12. The system of claim 10, wherein the processor is further configured to:
process source code to collect scalar accesses to elements within the input matrix resulting from execution of instructions in the source code;
insert the instructions into a directed acyclic graph (DAG) in accordance with data dependencies corresponding to the scalar accesses to the elements;
associate each instruction in the DAG with a marker that identifies the block corresponding to the instruction;
traverse the DAG to create a sequence of instructions minimizing a number of load and/or store operations;
map the instructions to a register cache; and
compile a modified source code in an intermediate representation based on the mapping, wherein the modified source code includes load and/or store operations that reference the at least one index buffer.

13. The system of claim 12, wherein the register cache comprises a collective register cache (CoRe) model that defines a plurality of infinite registers, and wherein multiple variables with non-intersecting liveness ranges and compatible type can be mapped to a single infinite register and different variables that interact are mapped to a particular lane of different infinite registers.

14. The system of claim 10, wherein the processor comprises a central processing unit (CPU) and the accelerator device comprises a graphics processing unit (GPU).

15. A non-transitory computer readable storage media storing instructions that, responsive to execution on a host computer, cause the host computer to perform operations in accordance with the method of claim 1.
